(19) United States
(12) Patent Application Publication
(10) Pub. No.: US 2025/0002717 A1
(43) Pub. Date: Jan. 2, 2025

(54) THERMOPLASTIC COMPOSITIONS AND USES THEREOF

(71) Applicant: SHPP GLOBAL TECHNOLOGIES B.V., Bergen op Zoom (NL)

(72) Inventors: Wei ZHAO, Evansville, IN (US); Laura Mely RAMIREZ, Evansville, IN (US); Hao ZHOU, Newburgh, IN (US); Peter Hendrikus Theodorus VOLLENBERG, Evansville, IN (US)

(21) Appl. No.: 18/709,904

(22) PCT Filed: Nov. 9, 2022
(86) PCT No.: PCT/IB2022/060784

§ 371 Date: May 14, 2024

(30) Foreign Application Priority Data
Nov. 15, 2021 (EP) 21208267.1

(51) Int. Cl. C08L 69/00; C08G 64/16; C08J 3/20

(52) U.S. Cl. CPC C08L 69/00; C08G 64/16; C08J 3/203; C08J 2369/00; C08J 2453/02; C08J 2483/04; C08L 2203/20; C08L 2205/025; C08L 2205/03; C08L 2207/20

(57) ABSTRACT

A thermoplastic composition includes particular amounts of a first polycarbonate including repeating units derived from a cyclohexylidene-bridged bisphenol and an impact modifier. The composition can provide a combination of good impact properties and scratch resistance.

### CROSS REFERENCE TO RELATED APPLICATION

This application claims priority to and the benefit of European Patent Application No. 21208267.1, filed on Nov. 15, 2021, the contents of which are incorporated by reference herein in their entirety.

### BACKGROUND

This disclosure relates to thermoplastic compositions, a method of forming the same, and articles derived therefrom.

Polycarbonate (PC) has excellent impact strength and transparency but tends to lack scratch-resistant properties. Efforts to improve scratch resistance include, for example, hard-coating the compositions or inclusion of anti-scratch additives into the compositions. These approaches may not be desirable in all applications. For example, in the case of hard-coating, an expensive additional processing step is introduced to the manufacturing process.

Accordingly, there remains a continuing need in the art for scratch-resistant compositions also having good mechanical properties including impact strength and tensile properties, good thermal properties, and high melt flow. Particularly desired are compositions that do not require a hard-coating or scratch resistant additives.

### SUMMARY

A thermoplastic composition comprises 45 to 95 weight percent of a first polycarbonate comprising repeating units derived from a cyclohexylidene-bridged bisphenol; an impact modifier comprising 5 to 13 or 15 to 25 weight percent of an elastomer-modified graft copolymer, or 5 to 15 weight percent of a block copolymer of an alkenyl aromatic and a conjugated diene, or 8 to 45 weight percent of a polycarbonate-siloxane copolymer, or a combination thereof; wherein weight percent is based on the total weight of the composition; wherein the thermoplastic composition comprises less than 1 weight percent of a flame retardant; and wherein when the impact modifier comprises the polycarbonate-siloxane copolymer, the composition optionally further comprises less than 20 weight percent of a poly(C₁₋₆ alkyl (meth)acrylate.

A method of making the composition comprises melt-mixing the components of the composition.

An article comprising the composition represents another aspect of the present disclosure.

The above described and other features are exemplified by the following detailed description.

### DETAILED DESCRIPTION

Provided herein is a composition having a combination of good scratch resistance and impact resistance. The composition includes particular amounts of a polycarbonate comprising repeating units derived from a cyclohexylidene-bridged bisphenol and an impact modifier. Addition of impact modifiers has previously negatively affected scratch visibility (e.g., by making scratches appear whiter). Surprisingly, the present inventors have identified polycarbonate compositions which can advantageously exhibit scratch resistance and have good impact performance.

Accordingly, a composition represents an aspect of the present disclosure. The composition comprises a first polycarbonate comprising repeating units derived from a cyclohexylidene-bridged bisphenol. The repeating units derived from the cyclohexylidene-bridged bisphenol can be according to formula (1)

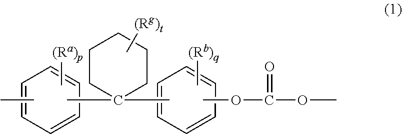

wherein R^{a} and R^{b} are each independently C₁₋₁₂ alkyl; R^{g} is C₁₋₁₂ alkyl; p and q are each independently 0 to 4; and t is 0 to 10. In an aspect, at least one of each of R^{a} and R^{b} are disposed meta to the cyclohexylidene bridging group. In an aspect, R^{a} and R^{b} are each independently C₁₋₄ alkyl, R^{g} is C₁₋₄ alkyl, p and q are each 0 or 1, and t is 0 to 5. In an aspect, R^{a}, R^{b}, and R^{g} are each methyl, p and q are each 0 or 1, and t is 0 or 3, preferably 0. In still another aspect, p and q are each 0, each R^{g} is methyl, and t is 3, such that the cyclohexylidene bridging group is 3,3-dimethyl-5-methyl cyclohexylidene. In another aspect, p and q are each 1, R^{a} and R^{b} are each methyl groups, and t is 0, such that the cyclohexylidene bridging group is an unsubstituted cyclohexylidene. For example, the first polycarbonate can comprise repeating units according to formula (2)

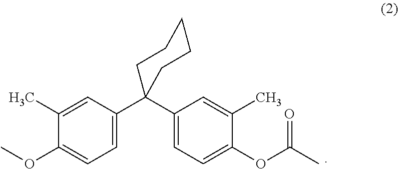

“Polycarbonates” as used herein includes homopolymers (e.g., wherein all repeating units are according to formula (1) or (2)), copolymers comprising repeating units derived from different bisphenols, and copolymers comprising carbonate units according to formula (1) or (2) and other types of polymer units, such as ester units or siloxane units.

In an aspect, the first polycarbonate can be a copolycarbonate further comprising repeating units derived from a bisphenol different from the cyclohexylidene-bridged bisphenol. For example, the copolycarbonate can comprise additional repeating units according to formula (3)

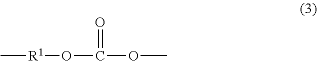

wherein each R¹ contains at least one C₆₋₃₀ aromatic group. For example, each R¹ can be derived from a dihydroxy compound such as an aromatic dihydroxy compound of formula (4) or a bisphenol of formula (5).

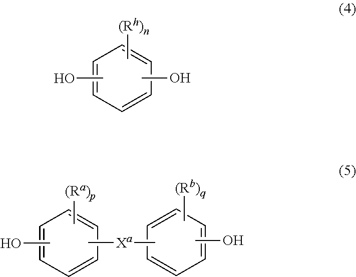

In formula (4), each Rh is independently a halogen atom, for example bromine, a C₁₋₁₀ hydrocarbyl group such as a C₁₋₁₀ alkyl, a halogen-substituted C₁-10 alkyl, a C₆₋₁₀ aryl, or a halogen-substituted C₆₋₁₀ aryl, and n is 0 to 4. In formula (5), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an aspect, p and q is each 0, or p and q is each 1, and R^{a} and R^{b} are each a C₁₋₃ alkyl group, preferably methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Examples of bisphenol compounds include 4,4′-dihydroxybiphenyl, 1,6-dihydroxynaphthalene, 2,6-dihydroxynaphthalene, bis(4-hydroxyphenyl) methane, bis(4-hydroxyphenyl)diphenylmethane, bis(4-hydroxyphenyl)-1-naphthylmethane, 1,2-bis(4-hydroxyphenyl) ethane, 1,1-bis(4-hydroxyphenyl)-1-phenylethane, 2-(4-hydroxyphenyl)-2-(3-hydroxyphenyl) propane, bis(4-hydroxyphenyl)phenylmethane, 2,2-bis(4-hydroxy-3-bromophenyl) propane, 1,1-bis(hydroxyphenyl)cyclopentane, 1,1-bis(4-hydroxyphenyl) isobutene, 1,1-bis(4-hydroxyphenyl)cyclododecane, trans-2,3-bis(4-hydroxyphenyl)-2-butene, 2,2-bis(4-hydroxyphenyl) adamantane, alpha, alpha′-bis(4-hydroxyphenyl) toluene, bis(4-hydroxyphenyl) acetonitrile, 2,2-bis(3-methyl-4-hydroxyphenyl) propane, 2,2-bis(3-ethyl-4-hydroxyphenyl) propane, 2,2-bis(3-n-propyl-4-hydroxyphenyl) propane, 2,2-bis(3-isopropyl-4-hydroxyphenyl) propane, 2,2-bis(3-sec-butyl-4-hydroxyphenyl) propane, 2,2-bis(3-t-butyl-4-hydroxyphenyl) propane, 2,2-bis(3-cyclohexyl-4-hydroxyphenyl) propane, 2,2-bis(3-allyl-4-hydroxyphenyl) propane, 2,2-bis(3-methoxy-4-hydroxyphenyl) propane, 2,2-bis(4-hydroxyphenyl) hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl) ether, bis(4-hydroxyphenyl) ether, bis(4-hydroxyphenyl) sulfide, bis(4-hydroxyphenyl) sulfoxide, bis(4-hydroxyphenyl) sulfone, 9,9-bis(4-hydroxyphenyl) fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl) phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), and 1,1-bis(4-hydroxyphenyl)-3,3,5-trimethylcyclohexane (isophorone bisphenol).

In an aspect, the first polycarbonate is a copolycarbonate further comprising repeating units derived from bisphenol A. For example, the first polycarbonate can comprise repeating units of formula (1) and (3a)

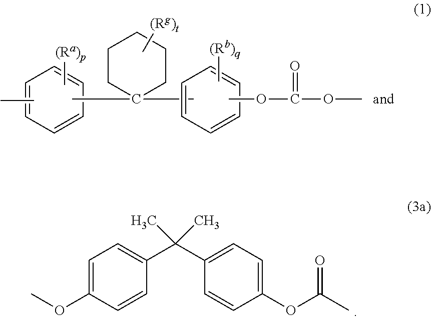

The cyclohexylidene-containing repeating units of formula (1) can be present in an amount of 10 to 50 wt. %, based on the total weight of the first polycarbonate.

In an aspect, the first polycarbonate can comprise repeating units of the formula (1a) and (3a)

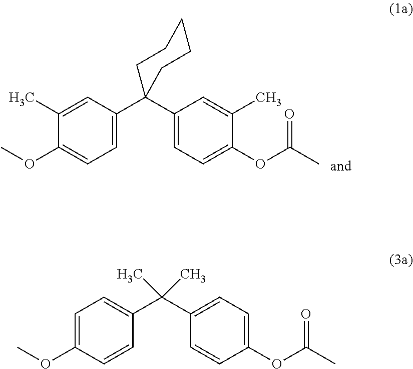

wherein the dimethyl bisphenol cyclohexane carbonate repeating units of formula (1a) can be present in an amount of 10 to 50 wt. %, based on the total weight of the first polycarbonate.

The first polycarbonate can be present in the composition in an amount of 45 to 95 weight percent, based on the total weight of the composition. Within this range, the first polycarbonate can be present in an amount of at least 48 weight percent, or at least 50 weight percent, or at least 65 weight percent, or at least 70 weight percent, or at least 75 weight percent, or at least 80 weight percent. Also within this range, the first polycarbonate can be present in an amount of at most 94.9 weight percent, or at most 90 weight percent, or at most 85 weight percent, or at most 84.9 weight percent, or at most 80 weight percent, or at most 79.9 weight percent, or at most 75 weight percent. In an aspect, the first polycarbonate can be present in an amount of 60 to 84.9 weight percent. In an aspect, the first polycarbonate can be present in an amount of 80 to 94.9 weight percent. In an aspect, the first polycarbonate can be present in an amount of 55 to 94.9 weight percent. In an aspect, the first polycarbonate can be present in an amount of 45 to 79.9 weight percent.

In addition to the first polycarbonate, the thermoplastic composition further comprises an impact modifier. In an aspect, the impact modifier can comprise an elastomer-modified graft copolymer, a block copolymer of an alkenyl aromatic and a conjugated diene, a polycarbonate-siloxane copolymer, or a combination thereof.

Elastomer-modified graft copolymers comprise (i) an elastomeric (i.e., rubbery) polymer phase having a glass transition temperature (Tg) less than or equal to 10° C., more preferably less than or equal to −10° C., or more preferably −40° C. to −80° C., and (ii) a rigid polymeric phase grafted to the elastomeric polymer phase. Elastomer-modified graft copolymers can be prepared by first providing the elastomeric polymer, then polymerizing the constituent monomer(s) of the rigid phase in the presence of the elastomer to obtain the graft copolymer. The grafts can be attached as graft branches or as shells to an elastomer core. The shell can merely physically encapsulate the core, or the shell can be partially or essentially completely grafted to the core.

Materials for use as the elastomer phase include, for example, conjugated diene rubbers; copolymers of a conjugated diene with less than or equal to 50 wt % of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene or styrene; or a combination thereof.

Conjugated diene monomers for preparing the elastomer phase include those of formula (6)

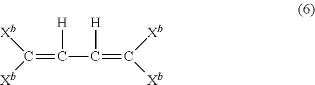

wherein each X^{b} is independently hydrogen, C₁₋₅ alkyl, or the like. Examples of conjugated diene monomers that can be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as a combination thereof. Specific conjugated diene homopolymers include polybutadiene and polyisoprene.

Copolymers of a conjugated diene rubber can also be used, for example those produced by aqueous radical emulsion polymerization of a conjugated diene and at least one monomer copolymerizable therewith. Monomers that are useful for copolymerization with the conjugated diene include monovinylaromatic monomers containing condensed aromatic ring structures, such as vinyl naphthalene, vinyl anthracene, and the like, or monomers of formula (7)

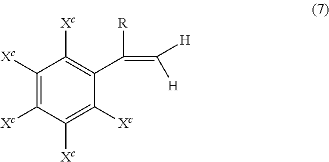

wherein each X^{e} is independently hydrogen, C₁₋₁₂ alkyl, C₃₋₁₂ cycloalkyl, C₆₋₁₂ aryl, C₇₋₁₂ aralkyl, C₇₋₁₂ alkylaryl, C₁₋₁₂ alkoxy, C₃₋₁₂ cycloalkoxy, C₆₋₁₂ aryloxy, chloro, bromo, or hydroxy, and R is hydrogen, C₁₋₅ alkyl, bromo, or chloro. monovinylaromatic monomers that can be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, or a combination thereof. Styrene or alpha-methylstyrene can be used as monomers copolymerizable with the conjugated diene monomer.

Other monomers that can be copolymerized with the conjugated diene are monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (8)

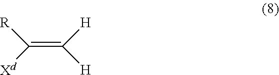

wherein R is hydrogen, C₁₋₅ alkyl, bromo, or chloro, and X^{d} is cyano, C₁₋₁₂ alkoxycarbonyl, C₁₋₁₂ aryloxycarbonyl, hydroxy carbonyl, or the like. Examples of monomers of formula (8) include acrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and a combination thereof. Monomers such as n-butyl acrylate, ethyl acrylate, and 2-ethylhexyl acrylate are commonly used as monomers copolymerizable with the conjugated diene monomer. Combinations of the foregoing monovinyl monomers and monovinylaromatic monomers can also be used.

(Meth)acrylate monomers for use in the elastomeric phase can be cross-linked, particulate emulsion homopolymers or copolymers of C₁₋₈ alkyl (meth)acrylates, in particular C₄₋₆ alkyl acrylates, for example n-butyl acrylate, t-butyl acrylate, n-propyl acrylate, isopropyl acrylate, 2-ethylhexyl acrylate, and the like, or a combination thereof. The C₁₋₈ alkyl (meth)acrylate monomers can optionally be polymerized in admixture with less than or equal to 15 wt % of comonomers of formulas (6), (7), or (8), based on the total monomer weight. comonomers include but are not limited to butadiene, isoprene, styrene, methyl methacrylate, phenyl methacrylate, phenethylmethacrylate, N-cyclohexylacrylamide, vinyl methyl ether or acrylonitrile, or a combination thereof. Optionally, less than or equal to 5 wt % of a polyfunctional crosslinking comonomer can be present, based on the total monomer weight. Such polyfunctional crosslinking comonomers can include, for example, divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, and the like, or a combination thereof.

The elastomer phase can be polymerized by mass, emulsion, suspension, solution or combined processes such as bulk-suspension, emulsion-bulk, bulk-solution or other techniques, using continuous, semi-batch, or batch processes. The particle size of the elastomer substrate is not critical. For example, an average particle size of 0.001 to 25 micrometers, preferably 0.01 to 15 micrometers, or even more preferably 0.1 to 8 micrometers can be used for emulsion based polymerized rubber lattices. A particle size of 0.5 to 10 micrometers, preferably 0.6 to 1.5 micrometers can be used for bulk polymerized rubber substrates. Particle size can be measured by simple light transmission methods or capillary hydrodynamic chromatography (CHDF). The elastomer phase can be a particulate, moderately cross-linked conjugated butadiene or C₄₋₆ alkyl acrylate rubber, and preferably has a gel content greater than 70%. Also useful are combinations of butadiene with styrene or C₄₋₆ alkyl acrylate rubbers.

The elastomeric phase comprises 5 to 95 wt % of the total graft copolymer, more preferably 20 to 90 wt %, and even more preferably 40 to 85 wt % of the elastomer-modified graft copolymer, the remainder being the rigid graft phase.

The rigid phase of the elastomer-modified graft copolymer can be formed by graft polymerization of a combination comprising a monovinylaromatic monomer and optionally at least one comonomer in the presence of at least one elastomeric polymer substrates. The above-described monovinylaromatic monomers of formula (7) can be used in the rigid graft phase, including styrene, alpha-methyl styrene, halostyrenes such as dibromostyrene, vinyltoluene, vinylxylene, butylstyrene, para-hydroxystyrene, methoxystyrene, or the like, or a combination thereof. Useful comonomers include, for example, the above-described monovinylic monomers or monomers of the general formula (8). In an aspect, R is hydrogen or C₁₋₂ alkyl, and X^{d} is cyano or C₁₋₁₂ alkoxycarbonyl. Comonomers for use in the rigid phase include acrylonitrile, methacrylonitrile, methyl (meth)acrylate, ethyl (meth)acrylate, n-propyl (meth)acrylate, isopropyl (meth)acrylate, and the like, and a combination thereof.

The relative ratio of monovinylaromatic monomer and comonomer in the rigid graft phase can vary widely depending on the type of elastomer substrate, type of monovinylaromatic monomer(s), type of comonomer(s), and the desired properties of the impact modifier. The rigid phase can generally comprise less than or equal to 100 wt % of monovinyl aromatic monomer, preferably 30 to 100 wt %, more preferably 50 to 90 wt % monovinylaromatic monomer, with the balance of the rigid phase being comonomer(s).

Depending on the amount of elastomer-modified polymer present, a separate matrix or continuous phase of ungrafted rigid polymer or copolymer can be simultaneously obtained along with the elastomer-modified graft copolymer. Typically, such impact modifiers comprise 40 to 95 wt % elastomer-modified graft copolymer and 5 to 65 wt % graft copolymer, based on the total weight of the impact modifier. In another aspect, such impact modifiers comprise 50 to 85 wt %, more preferably 75 to 85 wt % rubber-modified graft copolymer, together with 15 to 50 wt %, more preferably 15 to 25 wt % graft copolymer, based on the total weight of the impact modifier.

In an aspect, the aromatic vinyl copolymer comprises “free” styrene-acrylonitrile copolymer (SAN), i.e., styrene-acrylonitrile copolymer that is not grafted onto another polymeric chain. In a particular aspect, the free styrene-acrylonitrile copolymer can have a molecular weight of 50,000 to 200,000 Daltons on a polystyrene standard molecular weight scale and can comprise various proportions of styrene to acrylonitrile. For example, free SAN can comprise 75 weight percent styrene and 25 weight percent acrylonitrile based on the total weight of the free SAN copolymer. Free SAN can optionally be present by virtue of the addition of a grafted rubber impact modifier in the composition that contains free SAN, or free SAN can by present independent of other impact modifiers in the composition.

Processes known for the formation of the foregoing elastomer-modified graft copolymers include mass, emulsion, suspension, and solution processes, or combined processes such as bulk-suspension, emulsion-bulk, bulk-solution or other techniques, using continuous, semi-batch, or batch processes.

In an aspect the foregoing types of impact modifiers are prepared by an emulsion polymerization process that is free of basic materials such as alkali metal salts of C₆₋₃₀ fatty acids, for example sodium stearate, lithium stearate, sodium oleate, potassium oleate, and the like, alkali metal carbonates, amines such as dodecyl dimethyl amine, dodecyl amine, and the like, and ammonium salts of amines. Such materials are commonly used as surfactants in emulsion polymerization and can catalyze transesterification or degradation of polycarbonates. Instead, ionic sulfate, sulfonate or phosphate surfactants can be used in preparing the impact modifiers, particularly the elastomeric substrate portion of the impact modifiers. Useful surfactants include, for example, C₁₋₂₂ alkyl or C₇₋₂₅ alkylaryl sulfonates, C₁₋₂₂ alkyl or C₇₋₂₅ alkylaryl sulfates, C₁₋₂₂ alkyl or C₇₋₂₅ alkylaryl phosphates, substituted silicates, or a combination thereof. A specific surfactant is a C₆₋₁₆, preferably a C₈₋₁₂ alkyl sulfonate. This emulsion polymerization process is described and disclosed in various patents and literature of such companies as Dow and General Electric Company. In practice, any of the above-described impact modifiers can be used providing it is free of the alkali metal salts of fatty acids, alkali metal carbonates and other basic materials.

A specific impact modifier of this type is a methyl methacrylate-butadiene-styrene (MBS) impact modifier wherein the butadiene substrate is prepared using above-described sulfonates, sulfates, or phosphates as surfactants. Other examples of elastomer-modified graft copolymers in addition to ABS and MBS include but are not limited to acrylonitrile-styrene-butyl acrylate (ASA), methyl methacrylate-acrylonitrile-butadiene-styrene (MABS), and acrylonitrile-ethylene-propylene-diene-styrene (AES).

Specific elastomer-modified graft copolymers include those formed from styrene-butadiene rubber (SBR), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

In an aspect, the impact modifier can comprise a butadiene copolymer. In an aspect, the impact modifier can comprise a polycarbonate-butadiene.

The impact modifier can be a block copolymer of an alkenyl aromatic and a conjugated diene. The block copolymer can be hydrogenated or unhydrogenated. For brevity, this component can be referred to as a “hydrogenated block copolymer” or an “unhydrogenated block copolymer”.

The unhydrogenated block copolymer can comprise 10 to 90 weight percent of poly(alkenyl aromatic) content and 90 to 10 weight percent of poly(conjugated diene) content, based on the weight of the unhydrogenated block copolymer. In an aspect, the unhydrogenated block copolymer is a low poly(alkenyl aromatic content) unhydrogenated block copolymer in which the poly(alkenyl aromatic) content is 10 to less than 40 weight percent, or 20 to 35 weight percent, or 25 to 35 weight percent, or 30 to 35 weight percent, all based on the weight of the low poly(alkenyl aromatic) content unhydrogenated block copolymer. In an aspect, the unhydrogenated block copolymer is a high poly(alkenyl aromatic content) unhydrogenated block copolymer in which the poly(alkenyl aromatic) content is 40 to 90 weight percent, or 50 to 80 weight percent, or 60 to 70 weight percent, all based on the weight of the high poly(alkenyl aromatic content) unhydrogenated block copolymer.

In an aspect, the unhydrogenated block copolymer has a weight average molecular weight of 40,000 to 400,000 g/mol. The number average molecular weight and the weight average molecular weight can be determined by gel permeation chromatography and based on comparison to polystyrene standards. In an aspect, the unhydrogenated block copolymer has a weight average molecular weight of 200,000 to 400,000 g/mol, or 220,000 to 350,000 g/mol. In an aspect, the unhydrogenated block copolymer has a weight average molecular weight of 40,000 to 200,000 g/mol, or 40,000 to 180,000 g/mol, or 40,000 to 150,000 g/mol.

The alkenyl aromatic monomer used to prepare the unhydrogenated block copolymer can have the structure according to formula (9)

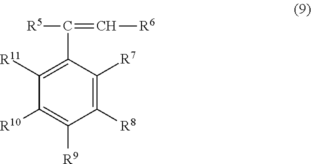

wherein R⁵ and R⁶ each independently represent a hydrogen atom, a C₁₋₈ alkyl group, or a C₂₋₈ alkenyl group; R⁷ and R¹¹ each independently represent a hydrogen atom, a C₁₋₈ alkyl group, a chlorine atom, or a bromine atom; and R⁸, R⁹, and R¹⁰ each independently represent a hydrogen atom, a C₁₋₈ alkyl group, or a C₂₋₈ alkenyl group, or R⁸ and R¹⁰ are taken together with the central aromatic ring to form a naphthyl group, or R⁹ and R¹⁰ are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In an aspect, the alkenyl aromatic monomer is styrene.

The conjugated diene used to prepare the unhydrogenated block copolymer can be a C₄₋₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In an aspect, the conjugated diene is 1,3-butadiene, 2-methyl-1,3-butadiene, or a combination thereof. In an aspect, the conjugated diene is 1,3-butadiene.

The unhydrogenated block copolymer is a copolymer comprising (A) at least one block derived from an alkenyl aromatic compound and (B) at least one block derived from a conjugated diene. The arrangement of blocks (A) and (B) includes a linear structure, a grafted structure, and a radial teleblock structure with or without a branched chain. Linear block copolymers include tapered linear structures and non-tapered linear structures. In an aspect, the unhydrogenated block copolymer has a tapered linear structure. In an aspect, the unhydrogenated block copolymer has a non-tapered linear structure. In an aspect, the unhydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In an aspect, the unhydrogenated block copolymer is a diblock copolymer, a triblock copolymer, or a combination thereof.

In an aspect, the unhydrogenated block copolymer excludes the residue of monomers other than the alkenyl aromatic compound and the conjugated diene. In an aspect, the unhydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In an aspect, the unhydrogenated block copolymer includes the residue of one or more acid functionalizing agents, such as maleic anhydride. In an aspect, the hydrogenated block copolymer comprises a polystyrene-poly(ethylene-butylene)-polystyrene triblock copolymer.

Methods for preparing unhydrogenated block copolymers are known in the art and many unhydrogenated block copolymers are commercially available. Illustrative commercially available unhydrogenated block copolymers include the polystyrene-polybutadiene-polystyrene triblock copolymers from Kraton Performance Polymers Inc. under the trade names D1101 and D1102; and the styrene-butadiene radial teleblock copolymers from Chevron Phillips Chemical Company under the trade names K-RESIN KR01, KR03, and KR-05.

The impact modifier can comprise a hydrogenated block copolymer. The hydrogenated block copolymer is the same as the unhydrogenated block copolymer, except that in the hydrogenated block copolymer the aliphatic unsaturated group content in the block (B) derived from a conjugated diene is at least partially reduced by hydrogenation. In an aspect, the aliphatic unsaturation in the (B) block is reduced by at least 50 percent, or at least 70 percent, or at least 90 percent.

Illustrative commercially available hydrogenated block copolymers include the polystyrene-poly(ethylene-propylene) diblock copolymers available from Kraton Performance Polymers Inc. as KRATON™ G1701 (having 37 weight percent polystyrene) and G1702 (having 28 weight percent polystyrene); the polystyrene-poly(ethylene-butylene)-polystyrene triblock copolymers available from Kraton Performance Polymers Inc. as KRATON™ G1641 (having 33 weight percent polystyrene), G1650 (having 30 weight percent polystyrene), G1651 (having 33 weight percent polystyrene), and G1654 (having 31 weight percent polystyrene); and the polystyrene-poly(ethylene-ethylene/propylene)-polystyrene triblock copolymers available from Kuraray as SEPTON™ S4044, S4055, S4077, and S4099. Additional commercially available hydrogenated block copolymers include polystyrene-poly(ethylene-butylene)-polystyrene (SEBS) triblock copolymers available from Dynasol as CALPRENE™ H6140 (having 31 weight percent polystyrene), H6170 (having 33 weight percent polystyrene), H6171 (having 33 weight percent polystyrene), and H6174 (having 33 weight percent polystyrene); and from Kuraray as SEPTON™ 8006 (having 33 weight percent polystyrene) and 8007 (having 30 weight percent polystyrene); polystyrene-poly(ethylene-propylene)-polystyrene (SEPS) copolymers available from Kuraray as SEPTON™ 2006 (having 35 weight percent polystyrene) and 2007 (having 30 weight percent polystyrene); and oil-extended compounds of these hydrogenated block copolymers available from Kraton Performance Polymers Inc. as KRATON™ G4609 (containing 45% mineral oil, and the SEBS having 33 weight percent polystyrene) and G4610 (containing 31% mineral oil, and the SEBS having 33 weight percent polystyrene); and from Asahi as TUFTEC™ H1272 (containing 36% oil, and the SEBS having 35 weight percent polystyrene). Mixtures of two of more hydrogenated block copolymers can be used.

In an aspect, the hydrogenated block copolymer comprises a polystyrene poly(ethylene-butylene)-polystyrene triblock copolymer having a weight average molecular weight of at least 100,000 grams per mole, or 200,000 to 400,000 grams per mole.

In an aspect, the hydrogenated block copolymer is a polystyrene-poly(ethylene-butylene)-polystyrene triblock copolymer having a polystyrene content of 10 to 50 weight percent, or 20 to 40 weight percent, or 20 to 35 weight percent, or 25 to 35 weight percent, based on the weight of the polystyrene-poly(ethylene-butylene)-polystyrene triblock copolymer. In these aspects, the polystyrene-poly(ethylene-butylene)-polystyrene triblock copolymer can, optionally, have a weight average molecular weight of 200,000 to 400,000 grams per mole, or 250,000 to 350,000 grams per mole, determined by size exclusion chromatography using polystyrene standards.

In an aspect, the impact modifier can comprise a polycarbonate-siloxane copolymer. Polycarbonate-siloxane copolymers are also known as polycarbonate-siloxanes. The polycarbonate-siloxane copolymer comprises carbonate repeat units and siloxane units. The carbonate units can be derived from a dihydroxy aromatic compound such as a bisphenol of formula (5) or a diphenol of formula (4), described above.

In an aspect in formulas (4) and (5), R^{a} and R^{b} are each independently C₁₋₃ alkyl or C₁₋₃ alkoxy, p and q are each independently 0 or 1, and X^{a} is a single bond, —O—, —S(O)—, —S(O)₂—, —C(O)—, a C₁₋₁₁ alkylidene of formula —C(R^{c})(R^{d})— wherein R^{e} and R^{d} are each independently hydrogen or C₁₋₁₀ alkyl, each Rh is independently bromine, a C₁₋₃ alkyl, a halogen-substituted C₁₋₃ alkyl, and n is 0 to 1.

In an aspect in formulas (4) and (5), R^{a} and R^{b} are each independently C₁₋₃ alkyl, p and q are each independently 0 or 1, and X^{a} is a single bond, —O—, —S(O)—, —S(O)₂—, —C(O)—, a C₁₋₁₁ alkylidene of formula —C(R^{c})(R^{d})— wherein R^{e} and R^{d} are each independently hydrogen or C₁₋₁₀ alkyl, each Rh is independently bromine, a C₁₋₃ alkyl, a halogen-substituted C₁₋₃ alkyl, and n is 0 to 1.

In an aspect in formula (5), p and q are each independently 0, and X^{a} is a single bond, —O—, —S(O)—, —S(O)₂—, —C(O)—, a C₁₋₁₁ alkylidene of formula —C(R^{c})(R^{d})— wherein R^{e} and R^{d} are each independently hydrogen or C₁₋₁₀ alkyl. In an aspect in formula (5), p and q are each independently 0, and X^{a} is a C₁₋₁₁ alkylidene of formula —C(R^{c})(R^{d})— wherein R^{e} and R^{d} are each independently hydrogen or C₁₋₁₀ alkyl. In an aspect in formula (5), p and q are each independently 0, and X^{a} is a C₁₋₁₁ alkylidene of formula —C(R^{c})(R^{d})— wherein R^{e} and R^{d} are each independently C₁₋₁₀ alkyl, preferably methyl.

In an aspect the carbonate units can be bisphenol carbonate units derived from bisphenols of formula (5). A preferred bisphenol is BPA.

The siloxane units (also referred to as polysiloxane blocks) are optionally of formula (10)

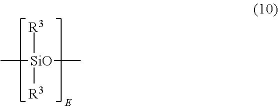

wherein each R³ is independently a C₁₋₁₃ monovalent organic group. For example, R³ can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆-14 aryl, C₆₋₁₀ aryloxy, C₇₋₁₃ arylalkylene, C₇₋₁₃ arylalkylenoxy, C₇₋₁₃ alkylarylene, or C₇₋₁₃ alkylarylenoxy. The foregoing groups can be fully or partially halogenated with fluorine, chlorine, bromine, or iodine, or a combination thereof. In an aspect, where a transparent poly(carbonate-siloxane) is desired, R³ is unsubstituted by halogen. Combinations of the foregoing R groups can be used in the same copolymer.

In an aspect, R³ is a C₁₋₃ alkyl, C₁₋₃ alkoxy, C₃₋₆ cycloalkyl, C₃₋₆ cycloalkoxy, C₆-14 aryl, C₆₋₁₀ aryloxy, C₇ arylalkylene, C₇ arylalkylenoxy, C₇ alkylarylene, or C₇ alkylarylenoxy. In an aspect, R³ is methyl, trifluoromethyl, or phenyl, preferably methyl.

The value of E in formula (10) can vary widely depending on the type and relative amount of each component in the polycarbonate composition, the desired properties of the composition, and like considerations. Generally, E has an average value of 2 to 1,000, or 2 to 500, 2 to 200, or 2 to 125, 5 to 80, or 10 to 70. In an aspect, E has an average value of 10 to 80 or 10 to 40, in still another aspect, E has an average value of 40 to 80 or 40 to 70, and in yet another aspect, E has an average value of 10 to 100, or 20 to 60, or 30 to 50.

In an aspect, the siloxane units are of formula (11)

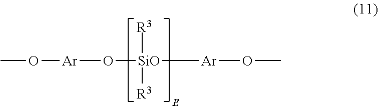

wherein E is as defined above in the context of formula (10); each R³ can be the same or different, and is as defined above in the context of formula (10); and Ar can be the same or different, and is a substituted or unsubstituted C₆₋₃₀ arylene, wherein the bonds are directly connected to an aromatic moiety. Ar groups in formula (11) can be derived from a C₆₋₃₀ dihydroxyarylene compound, for example a dihydroxy compound of formula (4). Exemplary dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane, or a combination thereof.

Specific examples of siloxane units of formula (11) include those of the formulas (11a) and (11b).

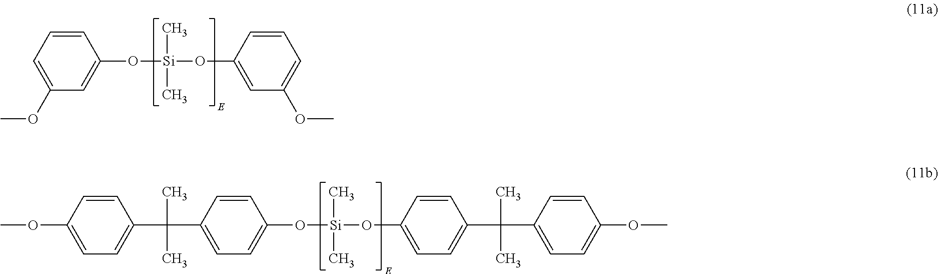

In an aspect, the siloxane units are of formula (12)

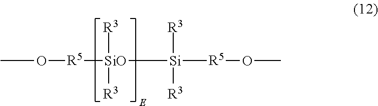

wherein R³ and E are as described above in the context of formula (10), and each R⁵ is independently a divalent C₁₋₃₀ organic group, and wherein the polymerized polysiloxane unit is the reaction residue of its corresponding dihydroxy compound. In an aspect, the polydiorganosiloxane blocks are of formula (13):

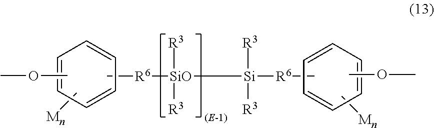

wherein R³ and E are as defined above in the context of formula (10). R⁶ in formula (13) is a divalent C₂₋₈ aliphatic group. Each M in formula (13) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ arylalkylenoxy, C₇₋₁₂ alkylarylene, or C₇₋₁₂ alkylarylenoxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R³ is a C₁₋₈ alkyl, haloalkyl such as trifluoropropyl, cyanoalkyl, or aryl such as phenyl, chlorophenyl or tolyl. In an aspect, R³ is methyl, or a combination of methyl and trifluoropropyl, or a combination of methyl and phenyl. In an aspect, R³ is methyl, M is methoxy, n is one, and R⁶ is a divalent C₁₋₃ aliphatic group. Specific polydiorganosiloxane blocks are of the formula

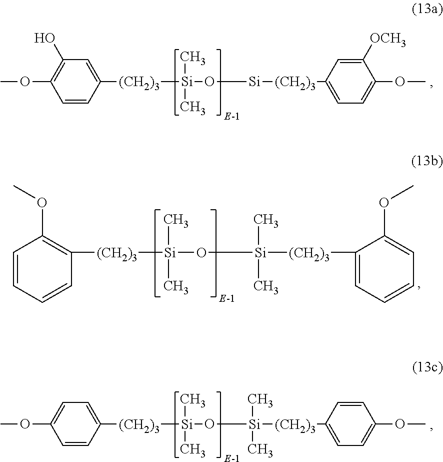

or a combination thereof, wherein E has an average value of 10 to 100, preferably 20 to 60, more preferably 30 to 50, or 40 to 50.

Blocks of formula (13) can be derived from the corresponding dihydroxy polydiorganosiloxanes by known methods. The polycarbonate-siloxane can be manufactured by introducing phosgene under interfacial reaction conditions into a mixture of bisphenol and an end capped polydimethylsiloxane (PDMS). Other known methods can also be used.

In an aspect, the poly(carbonate-siloxane) comprises carbonate units derived from bisphenol A, and repeating siloxane units (11a), (11b), (13a), (13b), (13c), or a combination thereof (preferably of formula 13a), wherein E has an average value of 10 to 100, preferably 20 to 80, or 30 to 70, more preferably 30 to 50 or 40 to 50.

The polycarbonate-siloxane copolymer can have a siloxane content of 10 to 70 weight percent. As used herein, “siloxane content” of a poly(carbonate-siloxane) refers to the content of siloxane units based on the total weight of the polycarbonate-siloxane copolymer. Within this range, the polycarbonate-siloxane copolymer can have a siloxane content of 20 to 65 weight percent, or 15 to 25 weight percent, or 30 to 70 weight percent, or 35 to 70 weight percent, or 35 to 65 weight percent.

The polycarbonate-siloxane copolymer can have a weight average molecular weight of 18,000 to 50,000 grams per mole (g/mol). Within this range, the polycarbonate-siloxane copolymer can have a weight average molecular weight of 25,000 to 40,000 g/mol, or 27,000 to 32,000 g/mol, or 21,000 to 50,000 g/mol, or 25,000 to 45,000 g/mol, or 30,000 to 45,000 g/mol, or 32,000 to 43,000 g/mol, or 34,000 to 41,000 g/mol, or 35,000 to 40,000 g/mol. In an aspect, the polycarbonate-siloxane copolymer can have a weight average molecular weight of 26,000 to 45,000 g/mol, or 30,000 to 45,000 g/mol, or 35,000 to 40,000 g/mol. The weight average molecular weight can be measured by gel permeation chromatography using a crosslinked styrene-divinyl benzene column, at a sample concentration of 1 milligram per milliliter, and as calibrated with bisphenol A polycarbonate standards.

In an aspect, the composition comprises less than or equal to 5 weight percent or less than or equal to 1 weight percent, or less than or equal to 0.1 weight percent of a polycarbonate-siloxane having a siloxane content of less than or equal to 10 weight percent. Preferably a polycarbonate-siloxane having a siloxane content of less than or equal to 10 weight percent is excluded from the composition.

In an aspect, when the impact modifier comprises the polycarbonate-siloxane copolymer, the composition optionally further comprises less than 20 weight percent of a poly(C₁₋₆ alkyl (meth)acrylate.

Combinations of any of the foregoing impact modifiers are also contemplated by the present disclosure. For example, in an aspect, the composition can include an impact modifier comprising the elastomer-modifier graft copolymer and the polycarbonate-siloxane copolymer.

In an aspect, the impact modifier can comprise styrene-ethylene-butylene-styrene, methacrylate-butadiene-styrene, acrylonitrile-butadiene-styrene, a polycarbonate-siloxane copolymer, or a combination thereof.

The impact modifier can be present in the thermoplastic composition in an amount of 5 to 55 weight percent. Within this range, the impact modifier can be present in an amount of at least 10 weight percent, or at least 20 weight percent, or at least 30 weight percent, or at least 40 weight percent, or at least 45 weight percent. Also within this range, the impact modifier can be present in an amount of at most 50 weight percent, or at most 40 weight percent, or at most 30 weight percent, or at most 20 weight percent, or at most 15 weight percent. For example, the impact modifier can be present in an amount of 5 to 45 weight percent, or 15 to 40 weight percent, or 10 to 20 weight percent, or 5 to 20 weight percent. When more than one impact modifier is present, the total amount of the combined impact modifiers can be 5 to 55 weight percent. For example if the impact modifier is present in an amount of 15 to 40 weight percent and comprises an elastomer-modified graft copolymer and a polycarbonate-siloxane copolymer, the elastomer-modified graft copolymer can be present in an amount of 5 to 15 weight percent and the polycarbonate-siloxane copolymer can be present in an amount of 10 to 25 weight percent.

In an aspect, the impact modifier can comprise 5 to 13 or 15 to 25 weight percent of an elastomer-modified graft copolymer, or 5 to 15 weight percent of a block copolymer of an alkenyl aromatic and a conjugated diene, or 8 to 45 weight percent of a polycarbonate-siloxane copolymer, or a combination thereof, wherein weight percent is based on the total weight of the composition.

In addition to the first polycarbonate and the impact modifier, the thermoplastic composition can optionally further comprise one or more additional thermoplastic polymers. Examples of thermoplastic polymers that can be used include polyacetals (e.g., polyoxyethylene and polyoxymethylene), poly(C₁₋₆ alkyl) acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylene sulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl) methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination thereof.

When present, any additional thermoplastic polymer is different from the first polycarbonate and the impact modifiers discussed above. In an aspect, the thermoplastic composition can optionally further comprise a second polycarbonate. The second polycarbonate comprises repeating units according to formula (3) and is different from the first polycarbonate. In an aspect, the second polycarbonate can be a polycarbonate homopolymer, preferably a bisphenol A homopolycarbonate.

The second polycarbonate can be a virgin polycarbonate or a recycled polycarbonate. In an aspect, the second polycarbonate can be a recycled polycarbonate. As used herein, the term “recycled polycarbonate” refers to a polycarbonate that is a post-industrial recycled polycarbonate, a post-consumer recycled polycarbonate, or a combination thereof. In an aspect, the recycled polycarbonate is a post-consumer recycled polycarbonate. The recycled polycarbonate generally comprises at least one impurity or residue that is not present in a corresponding, substantially similar or identical virgin polycarbonate.

The recycled polycarbonate (which can also be referred to as a recycled polycarbonate composition) comprises a polycarbonate. The polycarbonate of the recycled polycarbonate can comprise repeating units according to formula (3) as described previously. In an aspect, the recycled polycarbonate comprises repeating units derived from bisphenol A. In an aspect, the recycled polycarbonate comprises a linear bisphenol A polycarbonate homopolymer.

The recycled polycarbonate can further comprise one or more residual additives. The one or more residual additives can be present, for example, in an amount of 0.0001 to 40 weight percent, based on the total weight of the recycled polycarbonate. Within this range, the one or more residual additives can be present in an amount of 0.001 to 40 weight percent, or 0.01 to 40 weight percent, or 0.1 to 40 weight percent, or 0.1 to 30 weight percent, or 0.1 to 20 weight percent, or 0.1 to 10 weight percent, or 0.1 to 5 weight percent, or 0.1 to 1 weight percent. The one or more residual additives can include, but are not limited to, residual heat stabilizers, residual mold release agents, or derivatives or residues thereof.

The recycled polycarbonate can further optionally include one or more secondary polymers. A secondary polymer can be compatible or incompatible with the primary polycarbonate component of the recycled polycarbonate. An exemplary secondary polymer can include a polyester (e.g., polyethylene terephthalate, polybutylene terephthalate), a polyamide (e.g., Nylon), a polyolefin (e.g., LDPE, LLDPE), a polymeric impact modifier (e.g., high impact polystyrene (HIPS), a styrene acrylonitrile copolymer, a copolymer blend of styrene acrylonitrile and acrylate polymers, acrylonitrile butadiene styrene terpolymer), or a combination comprising at least one of the foregoing. When present, secondary polymers can be present in the recycled polycarbonate in an amount of 0.0001 to 40 weight percent, based on the total weight of the recycled polycarbonate. Within this range, the one or more residual additives can be present in an amount of 0.001 to 40 weight percent, or 0.01 to 40 weight percent, or 0.1 to 40 weight percent, or 0.1 to 30 weight percent, or 0.1 to 20 weight percent, or 0.1 to 10 weight percent, or 0.1 to 5 weight percent, or 0.1 to 1 weight percent, or 0.05 to 1 weight percent, or 0.1 to 0.25 weight percent.

The recycled polycarbonate can be recovered from a waste stream derived from one or more post-consumer sources including, but not limited to, office automation equipment, white goods, consumer electronics, automotive shredder residue, packaging waste, household waste and building waste and post-industrial molding and extrusion scrap.

In an aspect, the thermoplastic composition can optionally further include a poly(methyl methacrylate) homopolymer. Any suitable poly(methyl methacrylate) homopolymer can be used. In an aspect, the poly(methyl methacrylate) is a homopolymer obtained by polymerization (e.g., free radical polymerization) of a methyl methacrylate monomer. In an aspect, the weight average molecular weight of the poly(methyl methacrylate) can be, for example, 10,000 to 1,000,000 grams per mole (g/mol), or 20,000 to 1,000,000 g/mol, or 50,000 to 500,000 g/mol or 80,000 to 300,000 g/mol. Weight average molecular weight can be determined by gel permeation chromatography relative to poly(methyl methacrylate) standards. In an aspect, the poly(methyl methacrylate) can have a melt volume flow rate of 7 cm³/10 min to 12 cm³/10 at 240° C., 2.16 kg, 300 s as measured in accordance with ISO 1133. Poly(methyl methacrylate) can include, for example, poly(methyl methacrylate) available as ACRYLITE POQ66, available from Evonik, poly(methyl methacrylate) available as PLEXIGLAS V920A or ALTUGLAS V825T, both available from Arkema, and combinations thereof.

When present, the additional thermoplastic polymer can be present in an amount of 1 to 25 weight percent, based on the total weight of the composition. Within this range, the additional thermoplastic polymer can be present in an amount of 5 to 25 weight percent, or 10 to 25 weight percent, or 10 to 20 weight percent. In an aspect, when the additional thermoplastic polymer comprises a bisphenol A homopolycarbonate, the bisphenol A homopolycarbonate can be present in an amount of 10 to 20 weight percent, or 12 to 18 weight percent. In an aspect, when the additional thermoplastic polymer comprises a recycled polycarbonate, the recycled polycarbonate can be present in an amount of 5 to 25 weight percent, or 8 to 22 weight percent, or 10 to 20 weight percent. In an aspect, when the additional thermoplastic polymer comprises a poly(methyl methacrylate), the poly(methyl methacrylate) can be present in an amount of 10 to 20 weight percent, or 12 to 18 weight percent.

In an aspect, the thermoplastic composition can include an elastomer-modified graft copolymer impact modifier and a second polycarbonate, preferably wherein the second polycarbonate is a recycled polycarbonate. In an aspect, the thermoplastic composition can include an elastomer-modified graft copolymer impact modifier and a polycarbonate-siloxane impact modifier and a second polycarbonate, preferably wherein the second polycarbonate is a recycled polycarbonate. In an aspect, the thermoplastic composition can comprise a polycarbonate-siloxane copolymer impact modifier and a poly(methyl methacrylate). In an aspect, the thermoplastic composition can comprise a polycarbonate-siloxane copolymer impact modifier and a poly(methyl methacrylate) and a bisphenol A homopolycarbonate. In an aspect, the thermoplastic composition can comprise a polycarbonate-siloxane copolymer impact modifier and a bisphenol A homopolycarbonate.

The thermoplastic composition can optionally further comprise an additive composition. The additive composition can comprise one or more additive selected to achieve a desired property, with the proviso that the additive(s) are also selected so as to not significantly adversely affect a desired property of the thermoplastic composition. The additive composition or individual additives can be mixed at a suitable time during the mixing of the components for forming the composition. The additive can be soluble or non-soluble in polycarbonate. The additive composition can include a flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination thereof. For example, a combination of a heat stabilizer, mold release agent, and ultraviolet light stabilizer can be used. The additives can be used in amounts generally known to be effective. For example, the total amount of the additive composition (other than any impact modifier, filler, or reinforcing agent) can be 0.001 to 10 weight percent, or 0.01 to 5 weight percent, or 0.1 to 10 weight percent, each based on the total weight of the composition.

In an aspect, the composition can include a heat stabilizer additive. Heat stabilizer additives include organophosphites (e.g., triphenyl phosphite, tris-(2,6-dimethylphenyl) phosphite, tris-(mixed mono- and di-nonylphenyl)phosphite or the like), phosphonates (e.g., dimethylbenzene phosphonate or the like), phosphates (e.g., trimethyl phosphate, or the like), or a combination thereof. The heat stabilizer can be tris(2,4-di-t-butylphenyl) phosphate available as IRGAPHOS™ 168. Heat stabilizers are generally used in amounts of 0.01 to 5 wt %, based on the total weight of the composition.

There is considerable overlap among plasticizers, lubricants, and mold release agents, which include, for example, phthalic acid esters (e.g., octyl-4,5-epoxy-hexahydrophthalate), tris-(octoxycarbonylethyl) isocyanurate, di- or polyfunctional aromatic phosphates (e.g., resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); fatty acid esters (e.g., C₁₋₃₂ alkyl stearyl esters, such as methyl stearate and stearyl stearate and esters of stearic acid such as pentaerythritol tetrastearate, glycerol tristearate (GTS), and the like), waxes (e.g., beeswax, montan wax, paraffin wax, or the like), or a combination thereof. These are generally used in amounts of 0.01 to 5 wt %, based on the total weight of the composition.

Light stabilizers, in particular ultraviolet light (UV) absorbing additives, also referred to as UV stabilizers, include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB 5411 from Cytec) or a combination thereof. The UV stabilizers can be present in an amount of 0.01 to 1 wt %, preferably. 0.1 to 0.5 wt %, and more preferably, 0.15 to 0.4 wt %, based on the total weight of the composition.

Possible fillers or reinforcing agents include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well a combination thereof. The fillers and reinforcing agents can be coated with a layer of metallic material to facilitate conductivity, or surface treated with silanes to improve adhesion and dispersion with the polymer matrix. Fillers are used in amounts of 1 to 200 parts by weight, based on 100 parts by weight of the total composition.

Colorants such as pigment or dye additives can also be present. Useful pigments can include, for example, inorganic pigments such as metal oxides and mixed metal oxides such as zinc oxide, titanium dioxides, iron oxides, or the like; sulfides such as zinc sulfides, or the like; aluminates; sodium sulfo-silicates sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, enthrones, dioxazines, phthalocyanines, and azo lakes; Pigment Red 101, Pigment Red 122, Pigment Red 149, Pigment Red 177, Pigment Red 179, Pigment Red 202, Pigment Violet 29, Pigment Blue 15, Pigment Blue 60, Pigment Green 7, Pigment Yellow 119, Pigment Yellow 147, Pigment Yellow 150, Pigment Brown 24, Pigment Blue 29, or a combination thereof.

Dyes are generally organic materials and include coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; pyrazolone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene, chrysene, rubrene, coronene, or the like; or a combination thereof.

The thermoplastic composition comprises less than 1 weight percent of a flame retardant, based on the total weight of the composition. For example, the composition can comprise less than 0.5 weight percent, or less than 0.1 weight percent. In an aspect, a flame retardant can be excluded from the composition.

In an aspect, the thermoplastic composition can comprise 80 to 94.9 weight percent of the first polycarbonate; 5 to 20 weight percent of the impact modifier; and 0.1 to 10 weight percent of an additive composition. The first polycarbonate can comprise repeating units of formula

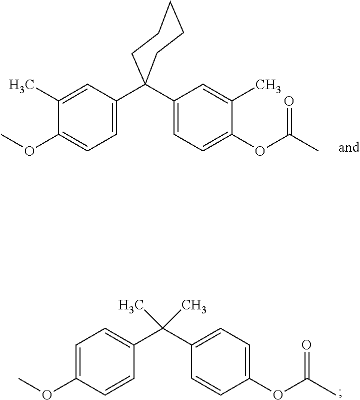

wherein the dimethyl bisphenol cyclohexane carbonate repeating units are present in an amount of 10 to 50 wt. %, based on the total weight of the first polycarbonate. The impact modifier can comprise an elastomer-modified graft copolymer.

In an aspect, the thermoplastic composition can comprise 60 to 84.9 weight percent of the first polycarbonate; 15 to 40 weight percent of the impact modifier, wherein the impact modifier comprises 5 to 15 weight percent of an elastomer-modified graft copolymer; and 10 to 25 weight percent of a polycarbonate siloxane copolymer having a siloxane content of 10 to 70 weight percent, preferably 20 to 65 weight percent, based on the total weight of the polycarbonate-siloxane copolymer; 0.1 to 10 weight percent of an additive composition; and optionally, 5 to 25 weight percent of a second polycarbonate that is different from the first polycarbonate, wherein the second polycarbonate is a recycled polycarbonate. The first polycarbonate can comprise repeating units of formula

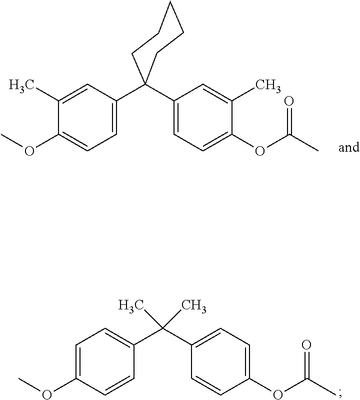

wherein the dimethyl bisphenol cyclohexane carbonate repeating units are present in an amount of 10 to 50 wt. %, based on the total weight of the first polycarbonate.

In an aspect, the thermoplastic composition can comprise 55 to 94.9 weight percent of the first polycarbonate; 5 to 45 weight percent of the impact modifier; and 0.1 to 10 weight percent of an additive composition. The first polycarbonate can comprise repeating units of formula

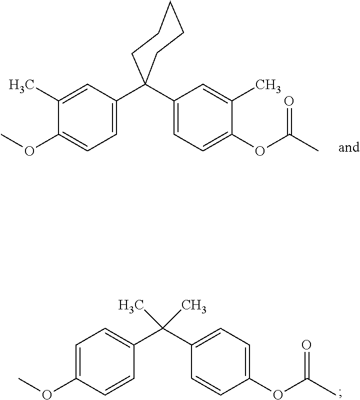

wherein the dimethyl bisphenol cyclohexane carbonate repeating units are present in an amount of 10 to 50 wt. %, based on the total weight of the first polycarbonate. The impact modifier can comprise a polycarbonate-siloxane copolymer having a siloxane content of 10 to 70 weight percent, preferably 20 to 65 weight percent, based on the total weight of the polycarbonate-siloxane copolymer.

In an aspect, the thermoplastic composition can comprise 45 to 79.9 weight percent of the first polycarbonate; 10 to 20 weight percent of the impact modifier; 10 to 20 weight percent of a poly(methyl methacrylate); 0.1 to 10 weight percent of an additive composition; and optionally, 10 to 20 weight percent of a second polycarbonate that is different from the first polycarbonate, wherein the second polycarbonate is a bisphenol A homopolycarbonate. The first polycarbonate can comprise repeating units of formula

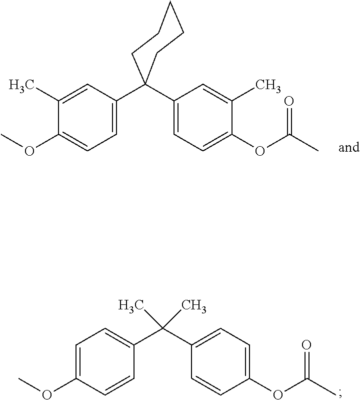

wherein the dimethyl bisphenol cyclohexane carbonate repeating units are present in an amount of 10 to 50 wt. %, based on the total weight of the first polycarbonate. The impact modifier can comprise a polycarbonate-siloxane copolymer having a siloxane content of 10 to 70 weight percent, preferably 20 to 65 weight percent, based on the total weight of the polycarbonate-siloxane copolymer.

The composition provided herein can exhibit good scratch resistance and good impact strength. For example, a molded sample of the composition can exhibit a notched Izod impact strength of greater than 40 J/m as measured in accordance with ASTM D256-10 under a load of 5 lbf at a temperature of 23° C.

A molded sample of the composition can also exhibit good scratch resistance. For example, a molded sample of the composition can exhibit a 10N scratch width that is within 20% of the scratch width of a composition not including the impact modifier. Scratch resistance can be determined according to the procedure further described in the working examples.

The thermoplastic composition of the present disclosure can be manufactured according to various methods. For example, the first polycarbonate, the second polycarbonate and other optional components can be first blended, optionally with any fillers, in a high-speed mixer or by hand-mixing. The blend is then fed into the throat of a twin-screw extruder via a hopper. Alternatively, at least one of the components can be incorporated into the composition by feeding it directly into the extruder at the through and/or downstream through a side stuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

Shaped, formed, casted, or molded articles comprising the composition are also provided. The composition can be molded into shaped articles by a variety of methods, such as injection molding, extrusion, rotational molding, blow molding, and thermoforming. The article can be a molded article, a thermoformed article, an extruded film, an extruded sheet, a honeycomb structure, one or more layers of a multi-layer article, a substrate for a coated article, or a substrate for a metallized article.

Articles comprising the composition can be used in various consumer products. In an aspect, the article can be an automotive component. In an aspect, the article can be a consumer electronic component, for example a housing for a consumer electronic device.

Articles can include, but are not limited to, exterior automobile components (e.g., grill, mirror housing, pillar, spoiler, logo, roof rail, bezel, trim, fender), interior automobile components (e.g., decorative parts, electronic housings, instrument panel components, navigation system, housing frames), storage boxes, a personal equipment part, a home appliance component, furniture, appliance housings (e.g., robot cleaners, drones), and consumer electronics devices (e.g., device housings or components for laptops, phones, tablets, batteries, wireless charging, AR/VR goggles).

In an aspect the article can be an automotive bumper, an automotive exterior component, an automobile mirror housing, an automobile wheel cover, an automobile instrument panel or trim, an automobile glove box, an automobile door hardware or other interior trim, an automobile exterior light, an automobile part within the engine compartment, an agricultural tractor or device part, a window or a component thereof, a construction equipment vehicle or device part, a marine or personal water craft part, an all-terrain vehicle or all-terrain vehicle part, plumbing equipment, a valve or pump, an air conditioning heating or cooling part, a furnace or heat pump part, a computer housing, a computer housing or business machine housing or part, a housing or part for monitors, a computer router, a desk top printer, a large office/industrial printer, an electronics part, a projector part, an electronic display part, a copier part, a scanner part, an electronic printer toner cartridge, a handheld electronic device housing, a housing for a hand-held device, a hair drier, an iron, a coffee maker, a toaster, a washing machine or washing machine part, a microwave, an oven, a power tool, an electric component, an electric enclosure, a lighting part, a component for a lighting fixture, a dental instrument, a medical instrument, a medical or dental lighting part, an aircraft part, a train or rail part, a seating component, a sidewall, a ceiling part, cookware, a medical instrument tray, an animal cage, fibers, a laser welded medical device, fiber optics, a lens (auto and non-auto), a cell phone part, a greenhouse component, a sun room component, a fire helmet, a safety shield, safety glasses, a gas pump part, a humidifier housing, a thermostat control housing, an air conditioner drain pan, an outdoor cabinet, a telecom enclosure or infrastructure, a Simple Network Detection System (SNIDS) device, a network interface device, a smoke detector, a component or device in a plenum space, a medical scanner, X-ray equipment, a component for a medical application or a device, an electrical box or enclosure, and an electrical connector, a construction or agricultural equipment, and a turbine blade.

In an aspect the article can be a component of an aircraft interior or a train interior, an access panel, access door, air flow regulator, air gasper, air grille, arm rest, baggage storage door, balcony component, cabinet wall, ceiling panel, door pull, door handle, duct housing, enclosure for an electronic device, equipment housing, equipment panel, floor panel, food cart, food tray, galley surface, handle, housing for television, light panel, magazine rack, telephone housing, partition, part for trolley cart, seat back, seat component, railing component, seat housing, shelve, side wall, speaker housing, storage compartment, storage housing, toilet seat, tray table, tray, trim panel, window molding, window slide, a balcony component, baluster, ceiling panel, cover for a life vest, cover for a storage bin, dust cover for a window, layer of an electrochromic device, lens for a television, electronic display, gauge, or instrument panel, light cover, light diffuser, light tube, light pipes, mirror, partition, railing, refrigerator door, shower door, sink bowl, trolley cart container, trolley cart side panel, or window.

This disclosure is further illustrated by the following examples, which are non-limiting.

### Examples

Materials used for the following examples are described in Table 1.

TABLE 1

| Component | Description | Supplier |
|---|---|---|
| PC-1 | Polycarbonate comprising repeating units derived from bisphenol A (BPA) | SABIC |
| | and dimethyl bisphenol cyclohexane (DMBPC), having a Mw of 22,000 to | |
| | 35,000 grams per mole as determined by gel permeation chromatography | |
| | relative to linear bisphenol A polycarbonate standards | |
| PC-2 | Linear bisphenol A polycarbonate having a Mw of 20,000-22,000 grams per | SABIC |
| | mole, as determined by gel permeation chromatography relative to linear | |
| | bisphenol A polycarbonate standards, produced by interfacial polymerization | |
| | and endcapped with p-cumylphenol | |
| PC-3 | Post-consumer recycled (PCR) polycarbonate from recycled polycarbonate | Ningbo |
| | parts which may contain typical additives such as heat stabilizers, UV | Xuri |
| | absorbers, mold release agents, or residues thereof in an amount of at least 1 | Hongyu |
| | ppm. | Technology |
| | | Co., Ltd |
| PC-4 | Linear bisphenol A polycarbonate having a Mw of 29,500-30,300 grams per | SABIC |
| | mole, as determined by gel permeation chromatography relative to linear | |
| | bisphenol A polycarbonate standards, produced by interfacial polymerization | |
| | and endcapped with p-cumylphenol | |
| PCSi-1 | Bisphenol A polycarbonate-polydimethylsiloxane block copolymer having a | SABIC |
| | siloxane content of 20 weight percent, average PDMS block length of 45 units, | |
| | having a Mw of 29,500 to 30,500 grams per mole as determined by gel | |
| | permeation chromatography relative to linear bisphenol A polycarbonate | |
| | standards, produced by interfacial polymerization and endcapped with p- | |
| | cumylphenol | |
| PCSi-2 | Polycarbonate-siloxane copolymer having a siloxane content of 40 weight | SABIC |
| | percent, average PDMS block length of 45 units, having a Mw of 37,000 to | |
| | 38,000 grams per mole as determined by gel permeation chromatography | |
| | relative to linear bisphenol A polycarbonate standards, produced by interfacial | |
| | polymerization and endcapped with p-cumylphenol | |
| MBS | Terpolymer of methyl methacrylate, butadiene and styrene, obtained as | Dow |
| | Paraloid ™ EXL-2691J | |
| ABS | Acrylonitrile-Butadiene-Styrene copolymer, obtained as VHRG resin with 1:1 | SABIC |
| | Antioxidant Emulsion (AOE) with primary and secondary antioxidants at a 1:1 | |
| | weight ratio, obtained as Cycolac ™ | |
| SEBS | High MW Polystyrene-poly(ethylene-butylene)-polystyrene block copolymer, | Kraton |
| | obtained as Kraton ™ G1651-J | |
| Acrylic IM | Poly(methyl methacrylate)-butyl acrylate copolymer, obtained as Paraloid ™ | Dow |
| | EXL-2335 | |
| SEBS-MA | Maliated polystyrene-poly(ethylene-butylene)-polystyrene block copolymer, | Kraton |
| | obtained as Kraton ™ FG1901 | |
| PMMA | Poly(methyl methacrylate), obtained as Altuglas V920 | Arkema |
| BZT-1 | 2-(2H-Benzotriazol-2-yl)-4,6-bis(2-phenyl-2-propanyl)phenol, obtained as | BASF |
| | TINUVIN 234 | |
| BZT-2 | 2-(2H-benzotriazol-2-yl)-4-(1,1,3,3-tetramethylbutyl)-phenol, obtained as | Cytec |
| | CYASORB 5411 | |
| PETS | Pentaerythritol tetrastearate, CAS Reg. No. 115-83-3 | FACI SpA |
| TBPP | Tris(2,4-di-tert-butylphenyl) phosphite, CAS Reg. No. 31570-04-4; obtained | BASF |
| | as IRGAFOS ™ 168 | |
| TiO₂ | Coated Titanium dioxide | KRONOS |
| Brightener | 2,2′-(1,2-ethenediyldi-4,1-phenylene)bisbenzoxazole; CAS 1533-45-5 | Eastman |
| | | Chemical |
| | | Co |
| Pigment Blue | Pigment Blue 29, CAS Reg. No. 57455-37-5 | Nubiola, Inc |
| 29 | | |
| Solvent Yellow | Solvent Yellow 93, CAS Reg. No. 4702-90-3, obtained as MACROLEX | Lanxess |
| 93 | Yellow 3G | |

The compositions of the following examples were prepared by blending the components together and extruding on a 37 mm twin-screw extruder at a temperature of 285 to 330° C., though it will be recognized by one skilled in the art that the method is not limited to these temperatures. The compositions were subsequently injection molded at a temperature of 285 to 380° C., though it will be recognized by one skilled in the art that the method is not limited to these temperatures.

Physical measurements were made using the tests and test methods described below.

Melt volume-flow rate (MVR) was determined in accordance with ASTM D1238 under a load of 1.2 kg at 300° C. with a dwell time of 360 s or 1080 s. Prior to the testing the pellets were pre-dried at 120° C. for 3 hours

High shear viscosity was determined in accordance with ISO 11443 at a temperature of 300° C.

Notched Izod impact Strength (INI) was determined in accordance with ASTM D256-10 under a load of 5 lbf at different temperatures including a temperature of 23° C. or −30° C. All ASTM INI determinations were carried out on sample plaques of 3.2 mm thickness. For the test at −30° C., the test specimens were placed in the freezer for more than 4 hours then taken out for testing at room temperature within five seconds.

Heat deflection temperature (HDT), expressed in units of ° C., was determined according to ASTM D648 at 1.82 MPa or 0.45 MPa using a bar having a thickness of 3.2 millimeters.

Tensile properties were measured in accordance with ASTM D638 at 50 mm/min at room temperature on standard ASTM tensile bars having a thickness of 3.2 millimeters.

Mold shrinkage values, expressed in units of percent, were determined by molding a standard “Dynatup” disk (see ASTM D3763-06) and measuring the actual part diameter in the flow (parallel) and cross-flow (perpendicular) directions. In the molding procedure, molten resin enters one edge of the disk-shaped mold and flows to the opposite edge, filling the mold as it goes. The reported mold shrinkage values are the average of mold shrinkage in the flow and cross-flow directions, where mold shrinkage in the flow direction=(mold diameter-flow diameter)/(mold diameter)×100; and mold shrinkage in the cross-flow direction=(mold diameter-cross-flow diameter)/(mold diameter)×100, wherein mold diameter is the disk diameter of the mold, flow diameter is the diameter of the molded disk in the direction of resin flow, and cross-flow diameter is the diameter of the molded disk perpendicular to the direction of resin flow.

Multiaxial impact (Dynatup Impact) testing, sometimes referred to as instrumented impact testing, was done as per ASTM D3763 using a 4×⅛ inch (101.6×3.2 mm) molded discs at various temperatures (23° C., −30° C.). The total energy absorbed by the sample was reported as J. Ductility is reported as a percent.

VICAT softening temperature is determined according to ASTM D 1525 or ISO 306.

Scratch resistance was evaluated using the 5-finger scratch test by Taber Industries, which is similar to the standard surface hardness scratch test method described in ASTM D7027-20 and ISO19252. A stylus pin is held at a 90 degree angle to the surface of a color plaque of 2.5 mm thickness and under a constant load of 10 Newtons downward force, then the plaques are dragged under the stylus pins. The width (in micrometers) of the resulting scratches produced on the surface under 10N load was measured with a microscope. Compositions comprising are shown in Tables 2A-2C, and results are shown in Tables 3A-3C. In Tables 2A-2C, the amount of each component is provided in weight percent, based on the total weight of the composition.

TABLE 2A

| Component | Units | E1 | E2 | CE1 | CE2 | E3 | E4 | E5 | E6 | E7 | E8 |
|---|---|---|---|---|---|---|---|---|---|---|---|
| PC-1 | wt % | 89.4 | 86.45 | 99.25 | 80 | 69.582 | 69.582 | 69.582 | 92.37 | 92.37 | 92.37 |
| PC-2 | wt % | | | | 14.5815 | | | | | | |
| PC-3 | wt % | | | | | | | | | | |
| PCSi-1 | wt % | | | | | 20 | | | | | |
| PCSi-2 | wt % | | | | | | 20 | 20 | | | |
| MBS | wt % | 10 | | | | 5 | 5 | | | | |
| ABS | wt % | | 12.93 | | | | | 5 | | | |
| SEBS | wt % | | | | | | | | 7 | | |
| Acrylic IM | wt % | | | | | | | | | 7 | |
| SEBS-MA | wt % | | | | | | | | | | 7 |
| BZT-1 | wt % | 0.3 | 0.3 | 0.3 | | | | | 0.3 | 0.3 | 0.3 |
| BZT-2 | wt % | | | | 0.3 | 0.3 | 0.3 | 0.3 | | | |
| PETS | wt % | 0.27 | 0.27 | 0.4 | 0.27 | 0.27 | 0.27 | 0.27 | 0.27 | 0.27 | 0.27 |
| TBPP | wt % | 0.06 | 0.05 | 0.05 | 0.06 | 0.06 | 0.06 | 0.06 | 0.06 | 0.06 | 0.06 |
| TiO₂ | wt % | | | | 4.76 | 4.76 | 4.76 | 4.76 | | | |
| Brightener | wt % | | | | 0.017 | 0.017 | 0.017 | 0.017 | | | |
| Pigment | wt % | | | | 0.0105 | 0.0105 | 0.0105 | 0.0105 | | | |
| Blue 29 | | | | | | | | | | | |
| Solvent | wt % | | | | 0.001 | 0.001 | 0.001 | 0.001 | | | |
| Yellow 93 | | | | | | | | | | | |

TABLE 2B

| Component | Units | E9 | CE3 | CE4 | E10 | E11 | E12 | E13 | E14 | E15 | E16 | E17 |
|---|---|---|---|---|---|---|---|---|---|---|---|---|
| PC-1 | wt % | 85.38 | 99.25 | 80 | 69.582 | 69.582 | 69.582 | 74.582 | 69.582 | 59.582 | 54.582 | 49.582 |
| PC-2 | wt % | | | 14.5815 | | | | | | | | |
| PC-3 | wt % | | | | | | | | 10 | 10 | 15 | 20 |
| PCSi-1 | wt % | | | | 20 | 17.5 | 15 | 10 | | 20 | 20 | 20 |
| PCSi-2 | wt % | | | | | | | 5 | 10 | | | |
| MBS | wt % | | | | 5 | 7.5 | 10 | 5 | 5 | 5 | 5 | 5 |
| ABS | wt % | | | | | | | | | | | |
| SEBS | wt % | | | | | | | | | | | |
| Acrylic IM | wt % | | | | | | | | | | | |
| SEBS-MA | wt % | 14 | | | | | | | | | | |
| [symbol] | [symbol] | | | | | | | | | | | |
| BZT-1 | wt % | 0.3 | 0.3 | | | | | | | | | |
| BZT-2 | wt % | | | 0.3 | 0.3 | 0.3 | 0.3 | 0.3 | 0.3 | 0.3 | 0.3 | 0.3 |
| PETS | wt % | 0.27 | 0.4 | 0.27 | 0.27 | 0.27 | 0.27 | 0.27 | 0.27 | 0.27 | 0.27 | 0.27 |
| TBPP | wt % | 0.05 | 0.05 | 0.06 | 0.06 | 0.06 | 0.06 | 0.06 | 0.06 | 0.06 | 0.06 | 0.06 |
| TiO₂ | wt % | | | 4.76 | 4.76 | 4.76 | 4.76 | 4.76 | 4.76 | 4.76 | 4.76 | 4.76 |
| Brightener | wt % | | | 0.017 | 0.017 | 0.017 | 0.017 | 0.017 | 0.017 | 0.017 | 0.017 | 0.017 |
| Pigment | wt % | | | 0.0105 | 0.0105 | 0.0105 | 0.0105 | 0.0105 | 0.0105 | 0.0105 | 0.0105 | 0.0105 |
| Blue 29 | | | | | | | | | | | | |
| Solvent | wt % | | | 0.001 | 0.001 | 0.001 | 0.001 | 0.001 | 0.001 | 0.001 | 0.001 | 0.001 |
| Yellow 93 | | | | | | | | | | | | |

[symbol]

indicates data missing or illegible when filed

TABLE 2C

| Component | Units | E18 | E19 | E20 | CE5 | CE6 | E21 | E22 | E23 | E24 | CE7 | CE8 | E25 | E26 |
|---|---|---|---|---|---|---|---|---|---|---|---|---|---|---|
| PC-1 | wt % | 89.37 | 84.37 | 79.37 | 79.998 | 99.38 | 89.4 | 79.4 | 69.4 | 59.4 | 99.25 | 80 | 64.582 | 49.582 |
| PC-2 | wt % | | | | 19.372 | | | | | | | 14.582 | | |
| PC-4 | wt % | | | | | | | | | | | | | 15 |
| PCSi-1 | wt % | | | | | | 10 | 20 | 30 | 40 | | | | |
| PCSi-2 | wt % | 10 | 15 | 20 | | | | | | | | | 15 | 15 |
| PMMA | wt % | | | | | | | | | | | | 15 | 15 |
| BZT-1 | wt % | 0.3 | 0.3 | 0.3 | 0.3 | 0.3 | 0.3 | 0.3 | 0.3 | 0.3 | 0.3 | | | |
| BZT-2 | wt % | | | | | | | | | | | 0.3 | 0.3 | 0.3 |
| PETS | wt % | 0.27 | 0.27 | 0.27 | 0.27 | 0.27 | 0.27 | 0.27 | 0.27 | 0.27 | 0.4 | 0.27 | 0.27 | 0.27 |
| TBPP | wt % | 0.06 | 0.06 | 0.06 | 0.06 | 0.05 | 0.06 | 0.06 | 0.06 | 0.06 | 0.05 | 0.06 | 0.06 | 0.06 |
| TiO₂ | wt % | | | | | | | | | | | 4.76 | 4.76 | 4.76 |
| Brightener | wt % | | | | | | | | | | | 0.017 | 0.017 | 0.017 |
| Pigment Blue | wt % | | | | | | | | | | | 0.0105 | 0.0105 | \|0.0105 |
| 29 | | | | | | | | | | | | | | |
| Solvent | wt % | | | | | | | | | | | 0.001 | 0.001 | 0.001 |
| Yellow 93 | | | | | | | | | | | | | | |

TABLE 3A

| Properties | Units | E1 | E2 | CE1 | CE2 | E3 | E4 | E5 | E6 | E7 | E8 |
|---|---|---|---|---|---|---|---|---|---|---|---|
| MVR (360 s) | cm³/10 min | 7.88 | 5.52 | 14.6 | 17.6 | 8.36 | 5.56 | 5.64 | 11.1 | 11.3 | 15.8 |
| MVR (1080 s) | cm³/10 min | | | | 19 | 9.7 | 6.74 | 7.35 | -0.1 | -34.5 | -6.5 |
| App. Shear Rate | 1/s | 640 | 640 | 640 | 640 | 640 | 640 | 640 | 640 | 640 | 640 |
| App. Viscosity | Pa-s | 303 | 341.9 | 285.6 | 268.7 | 335.5 | 356.7 | 351 | 304.5 | 314.2 | 223.2 |
| Tens. Mod. | MPa | 2100 | 2066 | 2472 | 2496 | 2042 | 1886 | 1922 | 2116 | 2174 | 2142 |
| Tens. Strength, | MPa | 63.3 | 60 | 78.9 | 73.5 | 57.4 | 53.2 | 53.7 | 64.5 | 66.5 | 67.5 |
| yield | | | | | | | | | | | |
| Tens. Strength, | MPa | 51.9 | 52.9 | 60.2 | 61.1 | 49.8 | 46.6 | 47.5 | 54 | 54.6 | 54.9 |
| break | | | | | | | | | | | |
| Tens. Elong., yield | % | 7.33 | 7.6 | 8.12 | 7.59 | 6.72 | 6.48 | 6.63 | 7.72 | 7.71 | 8.17 |
| Tens. Elong., break | % | 58.2 | 77.94 | 49.68 | 50.25 | 64.08 | 54.06 | 52.41 | 75.76 | 49.18 | 20.75 |
| Ductility, 23° C. | % | 0 | 0 | 0 | 0 | 0 | 100 | 100 | 0 | 0 | 0 |
| INI, 23° C. | J/m | 115 | 114 | 32.8 | 32.6 | 331 | 404 | 420 | 103 | 76.1 | 44.2 |
| Ductility, −30° C. | % | | | | 0 | 0 | 0 | 0 | | | |
| INI, −30° C. | J/m | | | | 32.9 | 107 | 188 | 183 | | | |
| HDT, 0.45 MPa | ° C. | 126 | 127.4 | 130.6 | 132.4 | 127.6 | 126.3 | 126.5 | 131.4 | 130.2 | 131.4 |
| HDT, 1.82 MPa | ° C. | 108 | 109.9 | 116.6 | 117.3 | 111.7 | 109.2 | 109.3 | 114.5 | 115.2 | 115.7 |
| MAI, Ductility | % | | | | 0 | 100 | 100 | 100 | | | |
| MAI, Energy to | J | | | | 40.4 | 57.9 | 49.3 | 55.4 | | | |
| max load, 23° C. | | | | | | | | | | | |
| MAI, Energy to | J | | | | 42.3 | 59.8 | 50.9 | 57 | | | |
| failure, 23° C. | | | | | | | | | | | |
| MAI, Energy, | J | | | | 42.1 | 60.5 | 51.1 | 57.1 | | | |
| Total, 23° C. | | | | | | | | | | | |
| MAI, Max Load, | kN | | | | 5.417 | 5.964 | 5.241 | 5.601 | | | |
| 23° C. | | | | | | | | | | | |
| MAI, Energy to | J | | | | | | | | | | |
| max load, −30° C. | | | | | | | | | | | |
| MAI, Energy to | J | | | | | | | | | | |
| failure, −30° C. | | | | | | | | | | | |
| MAI, Energy, | J | | | | | | | | | | |
| Total, −30° C. | | | | | | | | | | | |
| MAI, Max | kN | | | | | | | | | | |
| Load, −30° C. | | | | | | | | | | | |
| Mold Shrink, | % | | | | 0.79 | 0.95 | 1.03 | 1.01 | | | |
| parallel | | | | | | | | | | | |
| Mold Shrink, | % | | | | 0.81 | 1.06 | 1.13 | 1.07 | | | |
| perpendicular | | | | | | | | | | | |
| Vicat | ° C. | | | | 141 | 136 | 133 | 134 | | | |
| Scratch Width at | μm | 216.73 | 230.87 | 204.13 | 220.07 | 221.36 | 260.98 | 243.73 | 212.11 | 216.71 | 255.49 |
| 10N | | | | | | | | | | | |

TABLE 3B

| Properties | Units | E9 | CE3 | CE4 | E10 | E11 | E12 |
|---|---|---|---|---|---|---|---|
| MVR (360 s) | cm³/10 min | 17.4 | 15.1 | 16.9 | 8.59 | 7.76 | 6.58 |
| MVR (1080 s) | cm³/10 min | −15.5 | −3.7 | 19.6 | 9.42 | 8.43 | 6.99 |
| App. Shear Rate | 1/s | 640 | 640 | 640 | 640 | 640 | 640 |
| App. Viscosity | Pa-s | 160.5 | 289 | 273.4 | 333.1 | 314.2 | 306.2 |
| Tens. Mod. | MPa | 1850 | 2452 | 2580 | 2110 | 2034 | 1966 |
| Tens. Strength, | MPa | 57.6 | 77.9 | 75.6 | 59.7 | 57 | 54.5 |
| yield | | | | | | | |
| Tens. Strength, | MPa | 37 | 59.9 | 57.7 | 51.2 | 49.2 | 47.5 |
| break | | | | | | | |
| Tens. Elong., | % | 8.43 | 7.98 | 7.57 | 6.87 | 6.74 | 6.78 |
| yield | | | | | | | |
| Tens. Elong., | % | 48.6 | 61.19 | 64.38 | 56.4 | 50.01 | 68.5 |
| break | | | | | | | |
| Ductility, 23° C. | % | 20 | 0 | 0 | 20 | 0 | 0 |
| INI, 23° C. | J/m | 69 | 29.4 | 3.08 | 349 | 323 | 323 |
| Ductility, −30° C. | % | | | 0 | 0 | 0 | 0 |
| INI, −30° C. | J/m | | | 31.1 | 81.4 | 103 | 99 |
| HDT, 0.45 MPa | | 126.7 | 130.8 | 131.4 | 127.2 | 126.5 | 124.8 |
| HDT, 1.82 MPa | ° C. | 107.6 | 114.8 | 117.7 | 112.1 | 111 | 109.7 |
| MAI, Ductility | ° C. | | | 0 | 100 | 100 | 80 |
| MAI, Energy to | J | | | 47.6 | 57.5 | 48.9 | 50.8 |
| max load, 23° C. | | | | | | | |
| MAI, Energy to | J | | | 50.1 | 59.9 | 50.8 | 53 |
| failure, 23° C. | | | | | | | |
| MAI, Energy, | J | | | 50.1 | 60.2 | 51.2 | 55.3 |
| Total, 23° C. | | | | | | | |
| MAI, Max Load, | kN | | | 5.751 | 6.139 | 5.645 | 5.467 |
| 23° C. | | | | | | | |
| MAI, Energy to | J | | | 0 | 60 | 0 | 20 |
| max load, −30° C. | | | | | | | |
| MAI, Energy to | J | | | 2.06 | 57.1 | 35.4 | 54.6 |
| failure, −30° C. | | | | | | | |
| MAI, Energy, | J | | | 2.36 | 59.1 | 37 | 56 |
| Total, −30° C. | | | | | | | |
| MAI, Max | kN | | | 3.22 | 60.3 | 42.5 | 57.9 |
| Load, −30° C. | | | | | | | |
| Mold Shrink, | % | | | 1.339 | 6.923 | 5.47 | 6.589 |
| parallel | | | | | | | |
| Mold Shrink, | % | | | | | | |
| perpendicular | | | | | | | |
| Vicat | ° C. | | | | | | |
| Scratch Width at | μm | 320.69 | 203.02 | 205.78 | 212.60 | 218.04 | 231.31 |
| 10N | | | | | | | |

| Properties | Units | E13 | E14 | E15 | E16 | E17 |
|---|---|---|---|---|---|---|
| MVR (360 s) | cm³/10 min | 8.46 | 8.3 | 8.41 | 8.24 | 8.71 |
| MVR (1080 s) | cm³/10 min | 9.51 | 9.33 | 9.61 | 9.3 | 9.7 |
| App. Shear Rate | 1/s | 640 | 640 | 640 | 640 | 640 |
| App. Viscosity | Pa-s | 317.3 | 319.6 | 322.3 | 309.2 | 309.9 |
| Tens. Mod. | MPa | 2110 | 2068 | 2084 | 2070 | 2048 |
| Tens. Strength, | MPa | 59.5 | 58.5 | 58.8 | 58 | 57.7 |
| yield | | | | | | |
| Tens. Strength, | MPa | 50.2 | 50.4 | 49.7 | 49 | 48.4 |
| break | | | | | | |
| Tens. Elong., | % | 6.88 | 6.86 | 6.75 | 6.67 | 6.68 |
| yield | | | | | | |
| Tens. Elong., | % | 54.38 | 68.41 | 60.38 | 57.48 | 69.06 |
| break | | | | | | |
| Ductility, 23° C. | % | 0 | 0 | 100 | 0 | 100 |
| INI, 23° C. | J/m | 302 | 350 | 444 | 482 | 504 |
| Ductility, −30° C. | % | 0 | 0 | 0 | 0 | 0 |
| INI, −30° C. | J/m | 83.7 | 90.3 | 119 | 135 | 161 |
| HDT, 0.45 MPa | | 127.7 | 127.4 | 128.4 | 128.5 | 129.2 |
| HDT, 1.82 MPa | ° C. | 112.1 | 112.7 | 113.2 | 113.9 | 114.5 |
| MAI, Ductility | ° C. | 100 | 100 | 100 | 100 | 100 |
| MAI, Energy to | J | 56.6 | 58.2 | 58.8 | 57 | 57.8 |
| max load, 23° C. | | | | | | |
| MAI, Energy to | J | 59.5 | 60.5 | 61.5 | 59.5 | 60.1 |
| failure, 23° C. | | | | | | |
| MAI, Energy, | J | 59.7 | 60.7 | 61.9 | 59.5 | 60.1 |
| Total, 23° C. | | | | | | |
| MAI, Max Load, | kN | 6.088 | 6.144 | 6.08 | 5.985 | 5.978 |
| 23° C. | | | | | | |
| MAI, Energy to | J | 0 | 0 | 0 | 0 | 60 |
| max load, −30° C. | | | | | | |
| MAI, Energy to | J | 36 | 38.7 | 48.5 | 53.5 | 57.4 |
| failure, −30° C. | | | | | | |
| MAI, Energy, | J | 37.8 | 39.9 | 50.2 | 55 | 58.5 |
| Total, −30° C. | | | | | | |
| MAI, Max | kN | 46.2 | 46.2 | 53.9 | 58.2 | 59 |
| Load, −30° C. | | | | | | |
| Mold Shrink, | % | 5.797 | 5.55 | 6.108 | 6.428 | 6.524 |
| parallel | | | | | | |
| Mold Shrink, | % | | | | | |
| perpendicular | | | | | | |
| Vicat | ° C. | | | | | |
| Scratch Width at | μm | 223.33 | 244.53 | 227.24 | 223.51 | 238.89 |
| 10N | | | | | | |

TABLE 3C

| Properties | Units | E18 | E19 | E20 | CE5 | CE6 | E21 | E22 |
|---|---|---|---|---|---|---|---|---|
| MVR (360 s) | cm³/10 | 10.1 | 8.24 | 6.56 | 16.8 | 14.5 | 12 | 9.52 |
| | min | | | | | | | |
| MVR (1080 s) | cm³/10 | | | | | | | |
| | min | | | | | | | |
| App. Shear | 1/s | 640 | 640 | 640 | 640 | 640 | 640 | 640 |
| Rate | | | | | | | | |
| App. Viscosity | Pa-s | 334.1 | 342.5 | 354.6 | 281.2 | 304.8 | 305 | 320 |
| Tens. Mod. | MPa | 2240 | 2156 | 2062 | 2388 | 2452 | 2315 | 2204 |
| Tens. Strength, | MPa | 69.4 | 65.4 | 62.2 | 74.8 | 77.9 | 72.4 | 68.3 |
| yield | | | | | | | | |
| Tens. Strength, | MPa | 56 | 53.9 | 51.4 | 59.9 | 60.6 | 58.3 | 57.2 |
| break | | | | | | | | |
| Tens. Elong., | % | 7.56 | 7.36 | 7.2 | 7.81 | 7.99 | 7.76 | 7.42 |
| yield | | | | | | | | |
| Tens. Elong., | % | 66.95 | 55.62 | 54.01 | 65.08 | 51.21 | 59.5 | 94.6 |
| break | | | | | | | | |
| Ductility, 23° C. | % | 0 | 0 | 0 | 0 | 0 | 0 | 0 |
| INI, 23° C. | J/m | 54.6 | 65.6 | 85.5 | 36.6 | 32.9 | 36.7 | 54.4 |
| Ductility, −30° C. | % | | | | | | | |
| INI, −30° C. | J/m | | | | | | | |
| HDT, 0.45 | ° C. | | | | | | 131 | 131 |
| MPa | | | | | | | | |
| HDT, 1.82 | ° C. | 115 | 115 | 114.1 | 118.3 | 117.4 | 116 | 116 |
| MPa | | | | | | | | |
| MAI, Ductility | % | | | | | | | |
| MAI, Energy | J | | | | | | | |
| to max load, | | | | | | | | |
| 23° C. | | | | | | | | |
| MAI, Energy | J | | | | | | | |
| to failure, 23° C. | | | | | | | | |
| MAI, Energy, | J | | | | | | | |
| Total, 23° C. | | | | | | | | |
| MAI, Max | kN | | | | | | | |
| Load, 23° C. | | | | | | | | |
| MAI, | mm | | | | | | | |
| Deflection @ | | | | | | | | |
| Max Load, | | | | | | | | |
| 23° C. | | | | | | | | |
| Vicat | ° C. | | | | | | | |
| Scratch Width | μm | 218.89 | 231.93 | 246.07 | 221.87 | 187.38 | 208.93 | 215.40 |
| at 10N | | | | | | | | |

| Properties | Units | E23 | E24 | CE7 | CE8 | E25 | E26 |
|---|---|---|---|---|---|---|---|
| MVR (360 s) | cm³/10 | 7.31 | 5.6 | 14.6 | 17.6 | 9.89 | 8.32 |
| | min | | | | | | |
| MVR (1080 s) | cm³/10 | | | | 19 | 12.3 | 10.4 |
| | min | | | | | | |
| App. Shear | 1/s | 640 | 640 | 640 | 640 | 640 | 640 |
| Rate | | | | | | | |
| App. Viscosity | Pa-s | 340 | 355 | 285.6 | 268.7 | 219.5 | 251.2 |
| Tens. Mod. | MPa | 2136 | 2034 | 2472 | 2496 | 2258 | 2212 |
| Tens. Strength, | MPa | 65.3 | 61.8 | 78.9 | 73.5 | 64.2 | 62.5 |
| yield | | | | | | | |
| Tens. Strength, | MPa | 55.2 | 52.5 | 60.2 | 61.1 | 51.3 | 50.5 |
| break | | | | | | | |
| Tens. Elong., | % | 7.2 | 6.9 | 8.12 | 7.59 | 6.79 | 6.65 |
| yield | | | | | | | |
| Tens. Elong., | % | 77.4 | 64.1 | 49.68 | 50.25 | 57.7 | 64.36 |
| break | | | | | | | |
| Ductility, 23° C. | % | 0 | 100 | 0 | 0 | 0 | 0 |
| INI, 23° C. | J/m | 88.3 | 554 | 32.8 | 32.6 | 76.1 | 263 |
| Ductility, −30° C. | % | | | | 0 | 0 | 0 |
| INI, −30° C. | J/m | | | | 32.9 | 50.9 | 83.9 |
| HDT, 0.45 | ° C. | 131 | 130 | 130.6 | 132.4 | 123.2 | 124.4 |
| MPa | | | | | | | |
| HDT, 1.82 | ° C. | 114 | 115 | 116.6 | 117.3 | 104.3 | 105.6 |
| MPa | | | | | | | |
| MAI, Ductility | % | | | | 0 | 80 | 100 |
| MAI, Energy | J | | | | 40.4 | 42.7 | 53.3 |
| to max load, | | | | | | | |
| 23° C. | | | | | | | |
| MAI, Energy | J | | | | 42.3 | 48 | 55.4 |
| to failure, 23° C. | | | | | | | |
| MAI, Energy, | J | | | | 42.1 | 49.5 | 56.6 |
| Total, 23° C. | | | | | | | |
| MAI, Max | kN | | | | 5.417 | 5.271 | 5.927 |
| Load, 23° C. | | | | | | | |
| MAI, | mm | | | | 13.8 | 15.5 | 18 |
| Deflection @ | | | | | | | |
| Max Load, | | | | | | | |
| 23° C. | | | | | | | |
| Vicat | ° C. | | | | 141 | 129 | 129 |
| Scratch Width | μm | 228.04 | 252.73 | 204.13 | 220.07 | 208.56 | 216.82 |
| at 10N | | | | | | | |

As shown in Tables 3A and 3B, addition of an impact modifier such as MBS, ABS, SEBS, or acrylic impact modifiers can provide improved impact performance relative to the PC-1 resin alone. For example, the composition of CE1 includes 99.25 weight percent PC-1, with the balance being additives, exhibited a notched Izod impact strength at 23° C. of only 32.8 J/m. Addition of an impact modifier, for example as in E1, E2 and E6-9 led to an increased notched Izod impact strength at 23° C. of between 44.2-115 J/m, with some variation depending on the chemical identity and amount of the impact modifier.

E3-E5 and E10-13 demonstrate that the impact strength can be further improved with addition of a siloxane-containing polycarbonate. In these examples, the impact strength was further increased to 302-420 J/m. E14-E17 show that the further addition of a recycled polycarbonate resin can provide further improvement, with an impact strength at 23° C. ranging from 350-504 J/m.

As shown in Tables 3A-3B, the compositions of E1-E17 were observed to maintain good scratch resistance, with the 10N scratch width for each inventive example similar to the 10N scratch width measured for PC-1 alone.

As shown in Table 3C, addition of a siloxane-containing polycarbonate can provide improved impact performance relative to the PC-1 resin alone, even in the absence of other impact modifiers. For example, the composition of CE6 includes 99.38 weight percent PC-1, with the balance being additives, exhibited a notched Izod impact strength at 23° C. of 32.9 J/m. Addition of a bisphenol A homopolycarbonate, as in CE5, provided a similar notched Izod impact strength at 23° C. of 36.6 J/m.

In contrast, addition of a particular amount of a siloxane-containing polycarbonate led to an increased notched Izod impact strength at 23° C. ranging from 36.7 to 554 J/m, depending on the chemical identity and amount of the PC—Si component. The impact resistance could be further improved by addition of an acrylic polymer, such as PMMA in E26, exhibiting a notched Izod impact strength of 76.1 J/m. Addition of PMMA and a BPA homopolycarbonate, as in E27, further increased the notched Izod impact strength at 23° C. to 263 J/m.

As shown in Table 3C, the compositions based on a cyclohexylidene-bridged polycarbonate and siloxane-containing polycarbonates were observed to maintain good scratch resistance, with the 10N scratch width for each inventive example similar to the 10N scratch width measured for PC-1 alone.

Accordingly, a significant improvement is provided by the present disclosure, wherein the compositions can advantageously exhibit a desirable combination of good scratch resistance and impact strength.

This disclosure further encompasses the following aspects.

Aspect 1: A thermoplastic composition comprising: 45 to 95 weight percent of a first polycarbonate comprising repeating units derived from a cyclohexylidene-bridged bisphenol; an impact modifier comprising 5 to 13 or 15 to 25 weight percent of an elastomer-modified graft copolymer, or 5 to 15 weight percent of a block copolymer of an alkenyl aromatic and a conjugated diene, or 8 to 45 weight percent of a polycarbonate-siloxane copolymer, or a combination thereof; wherein weight percent is based on the total weight of the composition; wherein the thermoplastic composition comprises less than 1 weight percent of a flame retardant; and wherein when the impact modifier comprises the polycarbonate-siloxane copolymer, the composition optionally further comprises less than 20 weight percent of a poly(C₁₋₆ alkyl (meth)acrylate.

Aspect 2: The thermoplastic composition of aspect 1, wherein the impact modifier comprises the elastomer-modified graft copolymer, the block copolymer of an alkenyl aromatic and a conjugated diene, or a combination thereof, preferably styrene-ethylene-butylene-styrene, methacrylate-butadiene-styrene, acrylonitrile-butadiene-styrene, a butadiene copolymer, a polycarbonate-butadiene, or a combination thereof.

Aspect 3: The thermoplastic composition of aspect 2, wherein the impact modifier comprises the elastomer-modified graft copolymer and the polycarbonate siloxane copolymer, wherein the polycarbonate-siloxane copolymer has a siloxane content of 10 to 70 weight percent, preferably 20 to 65 weight percent, based on the total weight of the polycarbonate-siloxane copolymer.

Aspect 4: The thermoplastic composition of aspects 2 or 3, further comprising a second polycarbonate that is different from the first polycarbonate, wherein the second polycarbonate is a virgin polycarbonate or a recycled polycarbonate.

Aspect 5: The thermoplastic composition of aspect 1, wherein the impact modifier is the polycarbonate-siloxane copolymer, wherein the polycarbonate-siloxane copolymer has a siloxane content of 10 to 70 weight percent, preferably 20 to 65 weight percent, based on the total weight of the polycarbonate-siloxane copolymer.

Aspect 6: The thermoplastic composition of aspect 5, wherein the poly(C₁₋₆ alkyl (meth)acrylate) is present and comprises a poly(methyl methacrylate), preferably wherein the poly(methyl methacrylate) is present in an amount of 1 to less than 20 weight percent, or 1 to 18 weight percent.

Aspect 7: The thermoplastic composition of aspect 5 or 6, further comprising a second polycarbonate that is different from the first polycarbonate, wherein the second polycarbonate is a virgin polycarbonate or a recycled polycarbonate, preferably wherein the second polycarbonate is a bisphenol A homopolycarbonate.

Aspect 8: The thermoplastic composition of any of aspects 1 to 7, wherein a molded sample of the composition exhibits one or more of: a notched Izod impact strength at 23° C. of greater than 40 J/m, as determined according to ASTM D256-10; and a 10N scratch width that is within 20% of the scratch width of a composition not including the impact modifier.

Aspect 9: The thermoplastic composition of any of aspects 1 to 8, wherein the first polycarbonate comprises repeating units of the formula

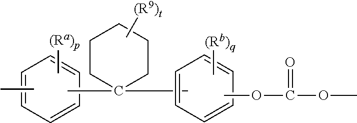

wherein R^{a} and R^{b} are each independently C₁₋₁₂ alkyl, preferably methyl; R^{g} is C₁₋₁₂ alkyl; p and q are each independently 0 to 4, preferably 1; and t is 0 to 10, preferably 0; and optionally, wherein the first polycarbonate further comprises repeating units derived from bisphenol A; preferably, wherein the first polycarbonate comprises repeating units of the formula

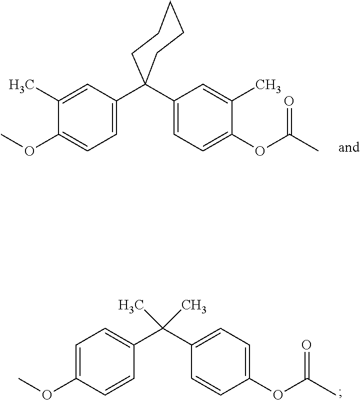

wherein the dimethyl bisphenol cyclohexane carbonate repeating units are present in an amount of 10 to 50 wt. %, based on the total weight of the first polycarbonate.

Aspect 10: The thermoplastic composition of aspect 1, comprising 80 to 94.9 weight percent of the first polycarbonate; 5 to 13 weight percent of the impact modifier; and 0.1 to 10 weight percent of an additive composition; wherein the first polycarbonate comprises repeating units of formula

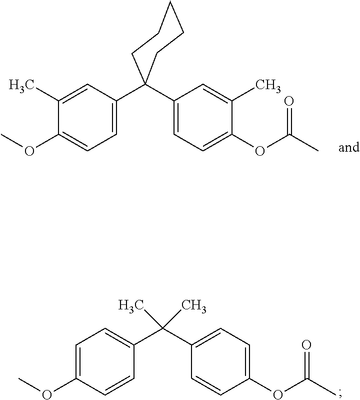

wherein the dimethyl bisphenol cyclohexane carbonate repeating units are present in an amount of 10 to 50 wt. %, based on the total weight of the first polycarbonate; and the impact modifier comprises an elastomer-modified graft copolymer.

Aspect 11: The thermoplastic composition of aspect 1, comprising 60 to 84.9 weight percent of the first polycarbonate; 15 to 40 weight percent of the impact modifier, wherein the impact modifier comprises 5 to 13 weight percent of the elastomer-modified graft copolymer; and 10 to 25 weight percent of the polycarbonate siloxane copolymer having a siloxane content of 10 to 70 weight percent, preferably 20 to 65 weight percent, based on the total weight of the polycarbonate-siloxane copolymer; 0.1 to 10 weight percent of an additive composition; and optionally, 5 to 25 weight percent of a second polycarbonate that is different from the first polycarbonate, preferably wherein the second polycarbonate is a recycled polycarbonate; wherein the first polycarbonate comprises repeating units of formula

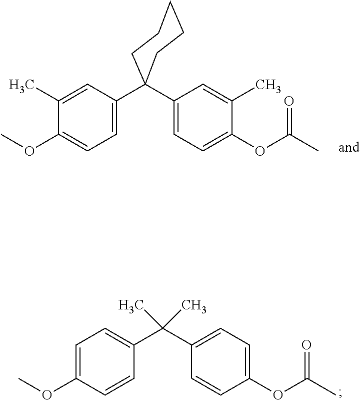

wherein the dimethyl bisphenol cyclohexane carbonate repeating units are present in an amount of 10 to 50 wt. %, based on the total weight of the first polycarbonate.

Aspect 12: The thermoplastic composition of aspect 1, comprising 55 to 94.9 weight percent of the first polycarbonate; 8 to 45 weight percent of the impact modifier; and 0.1 to 10 weight percent of an additive composition; wherein the first polycarbonate comprises repeating units of formula

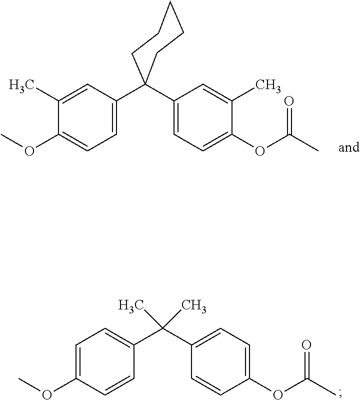

wherein the dimethyl bisphenol cyclohexane carbonate repeating units are present in an amount of 10 to 50 wt. %, based on the total weight of the first polycarbonate; and the impact modifier comprises a polycarbonate-siloxane copolymer having a siloxane content of 10 to 70 weight percent, preferably 20 to 65 weight percent, based on the total weight of the polycarbonate-siloxane copolymer.

Aspect 13: The thermoplastic composition of aspect 1, comprising 45 to 79.9 weight percent of the first polycarbonate; 10 to 20 weight percent of the impact modifier; 10 to 18 weight percent of a poly(methyl methacrylate); 0.1 to 10 weight percent of an additive composition; and optionally, 10 to 20 weight percent of a second polycarbonate that is different from the first polycarbonate, wherein the second polycarbonate is a bisphenol A homopolycarbonate; wherein the first polycarbonate comprises repeating units of formula

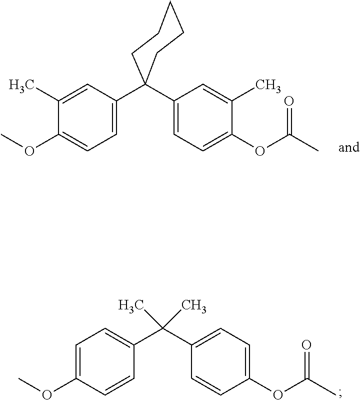

wherein the dimethyl bisphenol cyclohexane carbonate repeating units are present in an amount of 10 to 50 wt. %, based on the total weight of the first polycarbonate; and the impact modifier comprises a polycarbonate-siloxane copolymer having a siloxane content of 10 to 70 weight percent, preferably 20 to 65 weight percent, based on the total weight of the polycarbonate-siloxane copolymer.

Aspect 14: A method of making the composition of any of aspects 1 to 13, the method comprising: melt-mixing the components of the composition.

Aspect 15: An article comprising the composition of any of aspects 1 to 13, preferably wherein the article is a housing for a consumer electronic component.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects. Any aspect may be combined with any other aspect.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising:
45 to 95 weight percent of a first polycarbonate comprising repeating units derived from a cyclohexylidene-bridged bisphenol;
an impact modifier comprising
5 to 13 or 15 to 25 weight percent of an elastomer-modified graft copolymer, or
5 to 15 weight percent of a block copolymer of an alkenyl aromatic and a conjugated diene, or
8 to 45 weight percent of a polycarbonate-siloxane copolymer, or
a combination thereof;
wherein weight percent is based on the total weight of the composition;
wherein the thermoplastic composition comprises less than 1 weight percent of a flame retardant; and
wherein when the impact modifier comprises the polycarbonate-siloxane copolymer, the composition optionally further comprises less than 20 weight percent of a poly(C₁₋₆ alkyl (meth)acrylate.

2. The thermoplastic composition of claim 1, wherein the impact modifier comprises the elastomer-modified graft copolymer, the block copolymer of an alkenyl aromatic and a conjugated diene, or a combination thereof.

3. The thermoplastic composition of claim 2, wherein the impact modifier comprises the elastomer-modified graft copolymer and the polycarbonate siloxane copolymer, wherein the polycarbonate-siloxane copolymer has a siloxane content of 10 to 70 weight percent, based on the total weight of the polycarbonate-siloxane copolymer.

4. The thermoplastic composition of claim 2, further comprising a second polycarbonate that is different from the first polycarbonate, wherein the second polycarbonate is a virgin polycarbonate or a recycled polycarbonate.

5. The thermoplastic composition of claim 1, wherein the impact modifier is the polycarbonate-siloxane copolymer, wherein the polycarbonate-siloxane copolymer has a siloxane content of 10 to 70 weight percent weight percent, based on the total weight of the polycarbonate-siloxane copolymer.

6. The thermoplastic composition of claim 5, wherein the poly(C₁₋₆ alkyl (meth)acrylate) is present and comprises a poly(methyl methacrylate).

7. The thermoplastic composition of claim 5, further comprising a second polycarbonate that is different from the first polycarbonate, wherein the second polycarbonate is a virgin polycarbonate or a recycled polycarbonate.

8. The thermoplastic composition of claim 1, wherein a molded sample of the composition exhibits one or more of:
a notched Izod impact strength at 23° C. of greater than 40 J/m, as determined according to ASTM D256-10; and
a 10N scratch width that is within 20% of the scratch width of a composition not including the impact modifier.

9. The thermoplastic composition of claim 1, wherein the first polycarbonate comprises repeating units of the formula 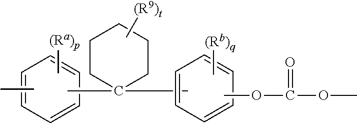
wherein
R^{a} and R^{b} are each independently C₁₋₁₂ alkyl;
R^{g} is C₁₋₁₂ alkyl;
p and q are each independently 0 to 4; and
t is 0 to 10; and
optionally, wherein the first polycarbonate further comprises repeating units derived from bisphenol A.

10. The thermoplastic composition of claim 1, comprising
80 to 94.9 weight percent of the first polycarbonate;
5 to 13 weight percent of the impact modifier; and
0.1 to 10 weight percent of an additive composition;
wherein
the first polycarbonate comprises repeating units of formula 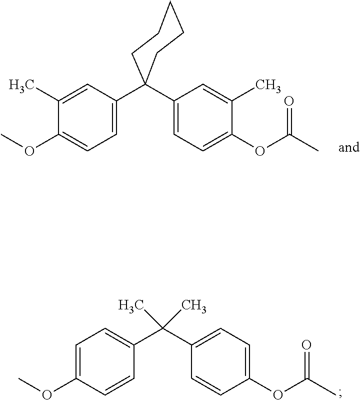
wherein the dimethyl bisphenol cyclohexane carbonate repeating units are present in an amount of 10 to 50 wt. %, based on the total weight of the first polycarbonate; and
the impact modifier comprises the elastomer-modified graft copolymer.

11. The thermoplastic composition of claim 1, comprising
60 to 84.9 weight percent of the first polycarbonate;
15 to 40 weight percent of the impact modifier, wherein the impact modifier comprises
5 to 13 weight percent of the elastomer-modified graft copolymer; and
10 to 25 weight percent of the polycarbonate siloxane copolymer having a siloxane content of 10 to 70 weight percent, based on the total weight of the polycarbonate-siloxane copolymer;
0.1 to 10 weight percent of an additive composition; and
optionally, 5 to 25 weight percent of a second polycarbonate that is different from the first polycarbonate;
wherein
the first polycarbonate comprises repeating units of formula 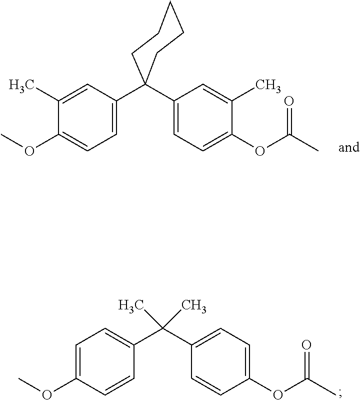
wherein the dimethyl bisphenol cyclohexane carbonate repeating units are present in an amount of 10 to 50 wt. %, based on the total weight of the first polycarbonate.

12. The thermoplastic composition of claim 1, comprising
55 to 91.9 weight percent of the first polycarbonate;
8 to 45 weight percent of the impact modifier; and
0.1 to 10 weight percent of an additive composition;
wherein
the first polycarbonate comprises repeating units of formula 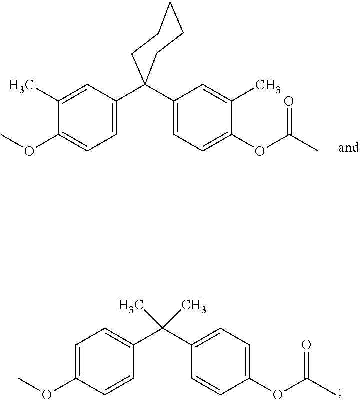
wherein the dimethyl bisphenol cyclohexane carbonate repeating units are present in an amount of 10 to 50 wt. %, based on the total weight of the first polycarbonate; and
the impact modifier comprises the polycarbonate-siloxane copolymer having a siloxane content of 10 to 70 weight percent, based on the total weight of the polycarbonate-siloxane copolymer.

13. The thermoplastic composition of claim 1, comprising
45 to 79.9 weight percent of the first polycarbonate;
10 to 20 weight percent of the impact modifier;
10 to 18 weight percent of a poly(methyl methacrylate);
0.1 to 10 weight percent of an additive composition; and
optionally, 10 to 20 weight percent of a second polycarbonate that is different from the first polycarbonate, wherein the second polycarbonate is a bisphenol A homopolycarbonate;
wherein
the first polycarbonate comprises repeating units of formula 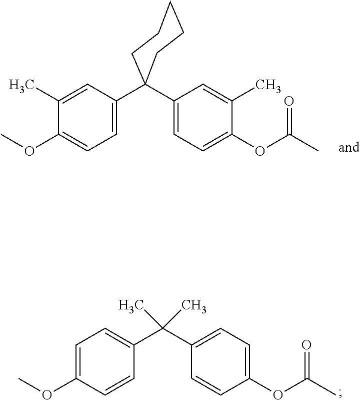
wherein the dimethyl bisphenol cyclohexane carbonate repeating units are present in an amount of 10 to 50 wt. %, based on the total weight of the first polycarbonate; and
the impact modifier comprises the polycarbonate-siloxane copolymer having a siloxane content of 10 to 70 weight percent, based on the total weight of the polycarbonate-siloxane copolymer.

14. A method of making the composition of claim 1, the method comprising:
melt-mixing the components of the composition.

15. An article comprising the composition of claim 1.

16. The article of claim 15, wherein the article is a housing for a consumer electronic component.
